(19) United States
(12) Patent Application Publication
(10) Pub. No.: US 2026/0211910 A1
(43) Pub. Date: Jul. 23, 2026

(54) EDGE INITIATED CONDITIONAL INSIGHT VERIFICATION

(71) Applicant: Dell Products L.P., Round Rock, TX (US)

(72) Inventors: OFIR EZRIELEV, Be'er Sheva (IL); LEV MAKLER, Be'er Sheva (IL); YEHONATAN COHEN, Ashdod (IL)

(21) Appl. No.: 19/035,101

(22) Filed: Jan. 23, 2025

(51) Int. Cl. G06F 16/3329; G06N 5/02; H04L 67/10

(52) U.S. Cl. CPC G06F 16/3329; H04L 67/10; G06N 5/02

(57) ABSTRACT

Methods and systems for managing operation of a distributed system are disclosed. The operation may be managed by using subnets of edge devices and/or the edge devices to provide various services. Each edge device may locally silo information to conserve available computing resources. When an edge device identifies that it needs access to information from other edge devices, the distributed system may perform a collaborative method of distributing limited amounts of information that is likely to be usable to meet the needs of the edge device.

### FIELD

Embodiments disclosed herein relate generally to managing operation of a distributed system. More particularly, embodiments disclosed herein relate to using subnets of edge devices and/or the edge devices to generate a final response to a prompt.

### BACKGROUND

Computing devices may provide computer-implemented services. The computer-implemented services may be used by users of the computing devices and/or devices operably connected to the computing devices. The computer-implemented services may be performed with hardware components such as processors, memory modules, storage devices, and communication devices. The operation of these components and the components of other devices may impact the performance of the computer-implemented services.

### BRIEF DESCRIPTION OF THE DRAWINGS

FIG. 1 shows a block diagram illustrating a first distributed system in accordance with an embodiment.

FIGS. 2A-2B show data flow diagrams in accordance with an embodiment.

FIG. 2C shows a block diagram illustrating a second distributed system in accordance with an embodiment.

FIGS. 2E-2F show block diagrams illustrating a third distributed system in accordance with an embodiment.

FIGS. 2D and 2G-2I show interaction diagrams in accordance with an embodiment.

FIGS. 3A-3B show a flow diagram illustrating a method in accordance with an embodiment.

FIG. 4 shows a block diagram illustrating a data processing system in accordance with an embodiment.

### DETAILED DESCRIPTION

Various embodiments will be described with reference to details discussed below, and the accompanying drawings will illustrate the various embodiments. The following description and drawings are illustrative and are not to be construed as limiting. Numerous specific details are described to provide a thorough understanding of various embodiments. However, in certain instances, well-known or conventional details are not described in order to provide a concise discussion of embodiments disclosed herein.

Reference in the specification to “one embodiment” or “an embodiment” means that a particular feature, structure, or characteristic described in conjunction with the embodiment can be included in at least one embodiment. The appearances of the phrases “in one embodiment” and “an embodiment” in various places in the specification do not necessarily all refer to the same embodiment.

References to an “operable connection” or “operably connected” means that a particular device is able to communicate with one or more other devices. The devices themselves may be directly connected to one another or may be indirectly connected to one another through any number of intermediary devices, such as in a network topology.

In general, embodiments disclosed herein relate to managing operation of a distributed system. The operation may be managed by using subnets of edge devices and/or the edge devices to generate a final response to a prompt.

During the operation, a first prompt may be received by a management system of the distributed system. The first prompt may include an input, such as (i) a query, (ii) a request, (iii) an instruction, (iv) a validation, and/or (v) any other type of input used to interact with the distributed system. At least one second prompt may be generated, using at least the first prompt, by a first generative trained machine learning model. The at least one second prompt may include similar content and/or different content compared to the first prompt and/or therefore utilize (i) at least one first attribute, (ii) at least one first capability, (iii) first information, and/or (iv) any other first data of at least one subnet of the distributed system.

The management system may initiate a first retrieval augmented generation (RAG) processing by transmitting the first prompt and/or the at least one second prompt to the at least one subnet. The at least one subnet may continue the first RAG by generating, using at least the first prompt and/or at least the at least one second prompt, at least one third prompt by a second generative trained machine learning model. The at least one third prompt may include similar content and/or different content compared to the first prompt and/or to the at least one second prompt and/or therefore utilize (i) at least one second attribute, (ii) at least one second capability, (iii) second information, and/or (iv) any other second data of at least one edge device of the distributed system.

The at least one subnet may continue the first retrieval augmented generation (RAG) processing by transmitting the first prompt and/or the at least one second prompt and/or the at least one third prompt to the at least one edge device. The at least one edge device may continue the first RAG by generating, using (i) the at least the first prompt, (ii) the at least one second prompt, (iii) the at least one third prompt, and/or (iv) local information of the at least one edge device, a first response using a third generative trained machine learning model.

The least one subnet may continue the first retrieval augmented generation (RAG) processing by receiving, from the at least one edge device, each first response of the at least one edge device to obtain a plurality of first responses. The plurality of the first responses may be ranked based on a first ranking criteria (e.g., first keyword use and/or first keyword frequency, any magnitude of relevancy to the first prompt and/or the at least one second prompt, and/or any other first criterium) to generate a ranked plurality of first responses. The plurality of the first responses may be ranked by generating, using (i) the first prompt. (ii) the at least one second prompt, and/or (iii) the first ranking criteria, the ranked plurality of the first responses using the second generative trained machine learning model.

The management system may perform a second RAG processing by (i) receiving at least a portion of the ranked plurality of the first responses and/or (ii) obtaining a final response to the first prompt. The final response may be obtained by (i) generating, using the first prompt and/or the at least the portion of the ranked plurality of the first responses, the plurality of final responses using the first generative trained machine learning model, and (ii) ranking the plurality of the final responses, using the first prompt and/or a second criteria, to generate the ranked plurality of the final responses using the first generative trained machine learning model. The second ranking criteria may include (i) a second keyword use and/or second keyword frequency, (ii) any magnitude of second relevancy to the first prompt, and/or (iii) any other second criterium. The final response to the prompt may include at least one of the ranked plurality of the final responses. The final response may be used by the management system to provide computer implemented services.

In an embodiment, a method for managing operation of a distributed system is disclosed. The method may include obtaining, by a management system and from an edge device of a subnet of the subnets, an insight package requesting information for verification of an insight for management of operation of the edge device; obtaining, by the management system and using the information as a prompt, a plurality of second prompts for subnets of the distributed system; initiating, by the management system, first retrieval augmented generation (RAG) processing of the plurality of the second prompts by the subnets using locally available data hosted by portions of the edge devices that are members of each of the subnets, the locally available data being used as knowledge sources for the first RAG processing to obtain a plurality of first responses from the subnets; performing, by the management system, second RAG processing of the prompt using the plurality of the first responses as a knowledge source for the second RAG processing to obtain a final response; and providing, by the management system, the final response to the edge device to facilitate continued provisioning of computer implemented services.

The method may also include using, by the edge device, the final response to confirm accuracy of an insight indicated by the insight package; selecting, by the edge device, a management action based on the confirmed accuracy; performing, by the edge device, the management action to update operation of the edge device to obtain an updated edge device; and providing, by the updated edge device, computer implemented services.

The management action may be one selected from a group of management actions consisting of: modifying a configuration of the edge device; changing a security posture of the edge device; disabling a software component hosted by the edge device; and changing workload acceptability criteria for the edge device.

The insight package may include a textual description of the information, and/or a textual description of a question regarding the information. The information may be recoverable using an answer to the question.

A first response of the plurality of the first responses may include a statement that is based on a plurality of data chunks from a portion of the edge devices that are members of a first subnet of the subnets.

The first response may be a portion of responses obtained from the portion of the edge devices during individual RAG processes performed during the first RAG processing.

The plurality of the first responses may be discriminated from the responses using ranking criteria.

The ranking criteria may take into account, at least, consistency between the plurality of the data chunks as a ranking basis.

Initiating the first RAG processing may include providing, by the management system, the plurality of the second prompts to respective subnet managers of the subnets to initiate generation and distribution of derived prompts to portions of the edge devices that are members of the respective subnets.

In an embodiment, a method for managing operation of a distributed system is disclosed. The method may include, based on a determination that a management system of the distributed system lacks sufficient information regarding edge devices of the distributed system to service a prompt submitted for processing by a first generative trained machine learning model hosted by the management system: (i) obtaining, by the management system and using the prompt, a plurality of second prompts for subnets of the distributed system, each of the subnets comprising a subnet manager and at least one of the edge devices, (ii) initiating, by the management system, first retrieval augmented generation (RAG) processing of the plurality of the second prompts by the subnets using locally available data hosted by portions of the edge devices that are members of each of the subnets, the locally available data being used as knowledge sources for the first RAG processing to obtain a plurality of first responses from the subnets, (iii) performing, by the management system, second RAG processing of the prompt using the plurality of the first responses as a knowledge source for the second RAG processing to obtain a final response, and (iv) providing, by the management system, computer implemented services using the final response.

A first response of the plurality of the first responses may include a statement that is based on a plurality of data chunks from a portion of the edge devices that are members of a first subnet of the subnets.

The first response may be a portion of responses obtained from the portion of the edge devices during individual RAG processes performed during the first RAG processing.

The plurality of the first responses may be discriminated from the responses using ranking criteria.

The ranking criteria may take into account, at least, consistency between the plurality of the data chunks as a ranking basis.

Initiating the first RAG processing may include providing, by the management system, the plurality of the second prompts to respective subnet managers of the subnets to initiate generation and distribution of derived prompts to portions of the edge devices that are members of the respective subnets.

The subnet manager may be adapted to customize each of the derived prompts based on a designated recipient of each of the derived prompts.

The subnet manager may be further adapted to obtain sub-responses based on the derived prompts and generate one of the plurality of the first responses.

The one of the plurality of responses may be based on a ranking of the derived prompts performed by the subnet manager based on ranking criteria that is different from other ranking criteria used by edge devices that are managed by the subnet manager.

Performing the second RAG processing may include (i) rank ordering the plurality of first responses based on relevancy to the prompt and (ii) using a portion of the plurality of the first responses as indicated by the rank ordering as context data for the prompt.

In an embodiment, a non-transitory media is provided. The non-transitory media may include instructions that when executed by a processor cause the computer-implemented method to be performed.

In an embodiment, a data processing system is provided. The data processing system may include the non-transitory media and a processor, and may perform the computer-implemented method when the computer instructions are executed by the processor.

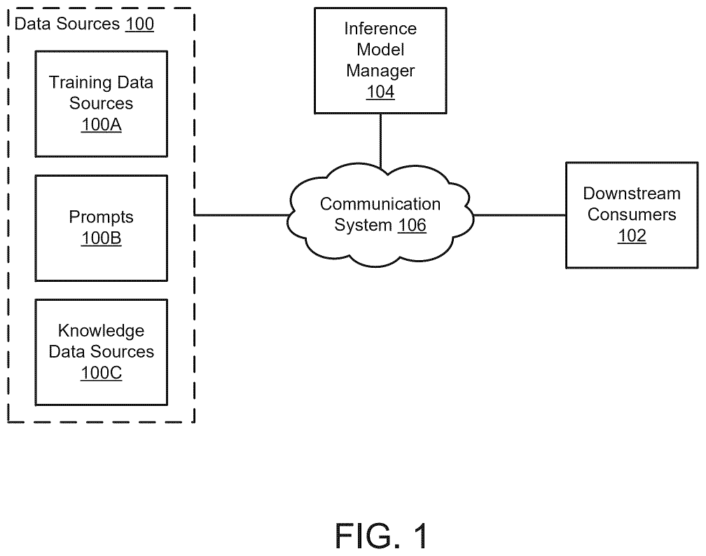

Turning to FIG. 1, a block diagram illustrating a first distributed system in accordance with an embodiment is shown. The system shown in FIG. 1 may provide computer-implemented services. The computer-implemented services may include any type and quantity of computer-implemented services. For example, the computer-implemented services may include communication services, data storage services, database services, data generation services, and/or any other type of service that may be implemented with a computing device.

The computer-implemented services may be provided by data processing systems to consumers of the computer-implemented services (e.g., users of the data processing systems, other data processing systems). To provide the computer-implemented services, operation of the data processing systems may be managed, for example, in accordance with policies (e.g., security policies, acceptable use policies). The policies may be enforced via updates to the operation of the data processing system over time to increase a likelihood of providing desired (e.g., secure, reliable) computer-implemented services.

The operation of the data processing system may be managed using artificial intelligence. For example, (trained) inference models may be used to assess, predict, and/or otherwise manage occurrences of events that may negatively impact provisioning of the computer-implemented services as desired, such as security events that may threaten the security of the data processing system (e.g., sensitive data accessible using the data processing systems).

To do so, an inference model such as a generative machine-learning model may be trained to generate a response to (e.g., an inference based on) ingest data. For example, the ingest data may include information regarding programs being executed by components of a data processing system, and the inference model may be trained to identify, based on the ingest data, a security threat to the data processing system and/or actions for managing the security threat. To manage the security threat, the inference may be provided to a downstream process during which operation of the data processing system may be updated in a manner that mitigates an undesired outcome of the security threat.

However, the responses obtained from the (trained) inference models may not be reliable for managing the operation of the data processing systems if informational content of the ingest data used during inferencing is inadequate. For example, terms (e.g., words and/or phrases) included in the prompt may be ambiguous and/or may have special meaning (e.g., a term may have different meaning to an operator of the inference models than a meaning based on its dictionary definition). Therefore, to increase a likelihood of generating reliable responses during inferencing, a retrieval-augmented generation process may be implemented to improve informational content of the ingest data to the inference models. To do so, the prompt may undergo preprocessing, during which context data may be obtained for terms present in the prompt.

For example, to obtain expected quality (e.g., adequate) ingest data, the prompt may be provided to a data pipeline. The data pipeline may include a retrieval process, during which terms in the prompt are identified, and context data for the identified terms is obtained. For example, the retrieval process may use methods to (i) identify terms present in the prompt that may require context data, (ii) identify portions of context data from a trusted data source based on the identified terms, (iii) rank the identified portions of context data, and/or (iv) select a number of the ranked identified portions of context data for use as the context data.

However, due to limitations of these methods, not all terms that require context data may be identified and/or context data may not be obtained for all of the identified terms. Consequently, the context data may be insufficient for generating adequate ingest data. If the ingest data is inadequate, then a subsequent inferencing process that uses the inadequate ingest data may be likely to provide unreliable inferences, and outcomes of downstream processes (e.g., management processes for the data processing systems) that use the inferences may be undesirable.

In general, embodiments disclosed herein may provide methods, systems, and/or devices for managing operation of data processing systems using inference models in a manner that is more likely to result in desirable management outcomes. To do so, prompts for processing by the inference models may be preprocessed using an iterative retrieval process that continues to retrieve context data until the context data meets sufficiency criteria. For example, the sufficiency criteria may specify a minimum level of content of the context data with respect to ontology definitions (e.g., defined by an operator of the inference models). The ontology definitions may include a list of ontology terms for which context data is to be retrieved when instances of the ontology terms are present in the prompt. The retrieval process may be performed iteratively until sufficient context data has been retrieved for each instance of an ontology term present in the prompt.

By doing so, the context data obtained during prompt preprocessing may be more likely to be sufficient for providing adequate ingest data to the inference models, thereby increasing a likelihood of the inferences being reliable for use in managing the operation of the data processing systems.

To provide the above-mentioned functionality, the distributed system of FIG. 1 may include data sources 100, downstream consumers 102, inference model manager 104, and communication system 106. The distributed system, any components thereof, and/or any other types of devices or components not shown in FIG. 1 may perform all, or a portion of the computer-implemented services independently and/or cooperatively. Each of these components is discussed below.

Data sources 100 may include any type and/or number of data sources. Each of data sources 100 may include hardware and/or software components configured to obtain data, store data, provide data to other entities, and/or to perform any other tasks to facilitate performance of computer-implemented services. Different data sources of data sources 100 may facilitate similar and/or different computer-implemented services. For example, data sources 100 may include training data sources 100A, prompts 100B, knowledge data sources 100C, and/or other sources of data usable to facilitate operation of inference models.

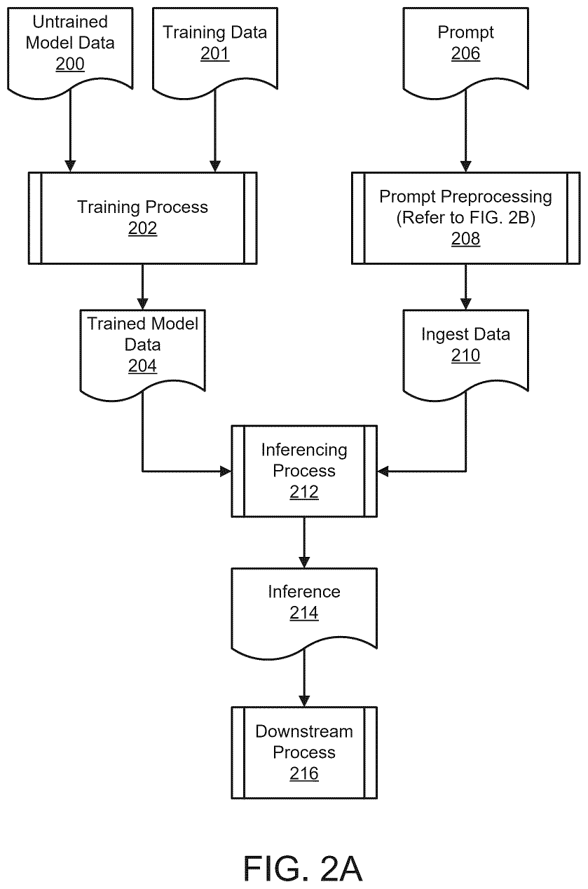

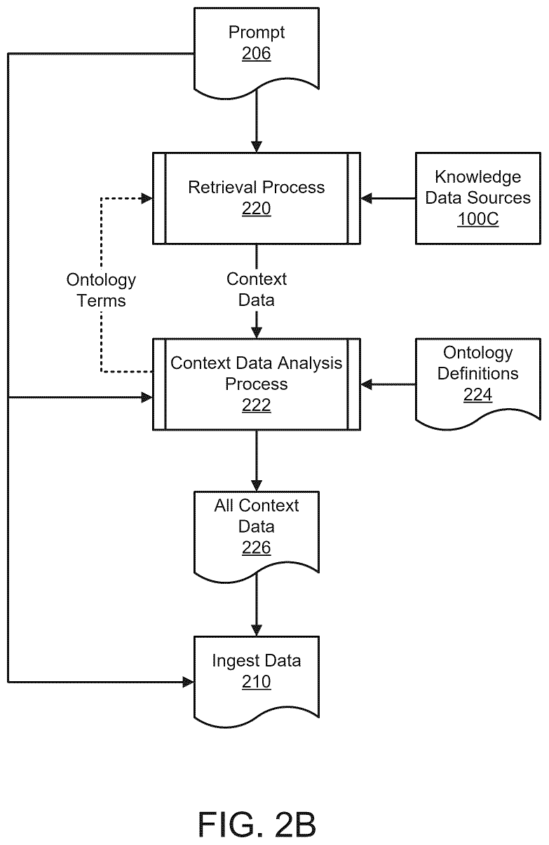

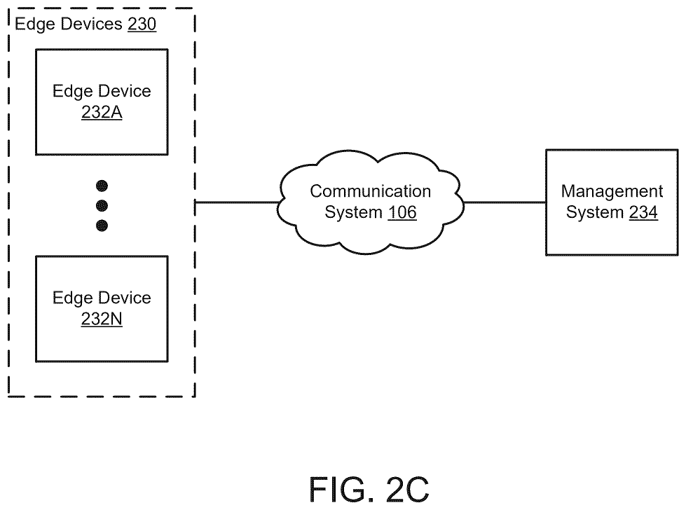

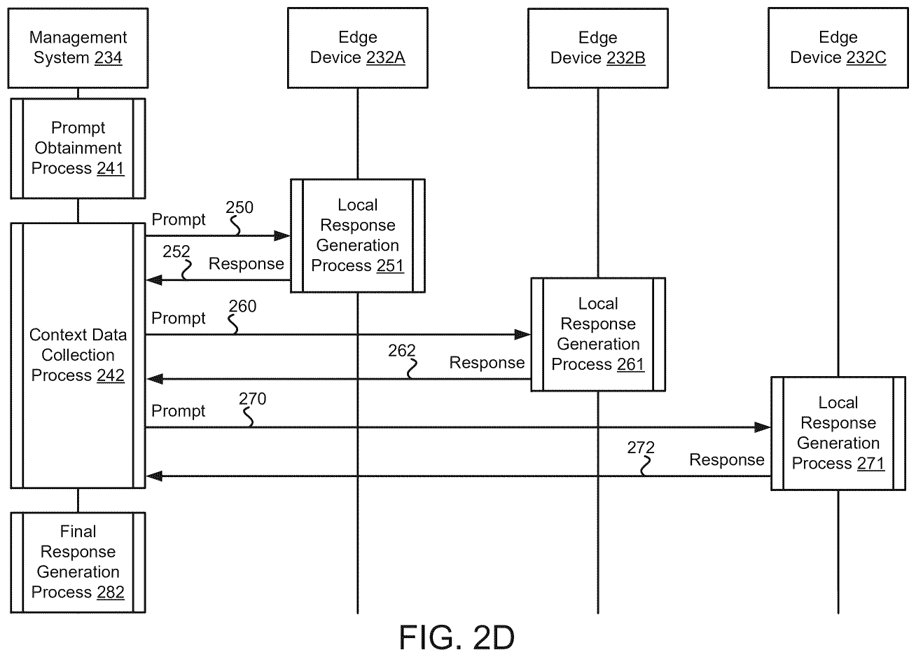

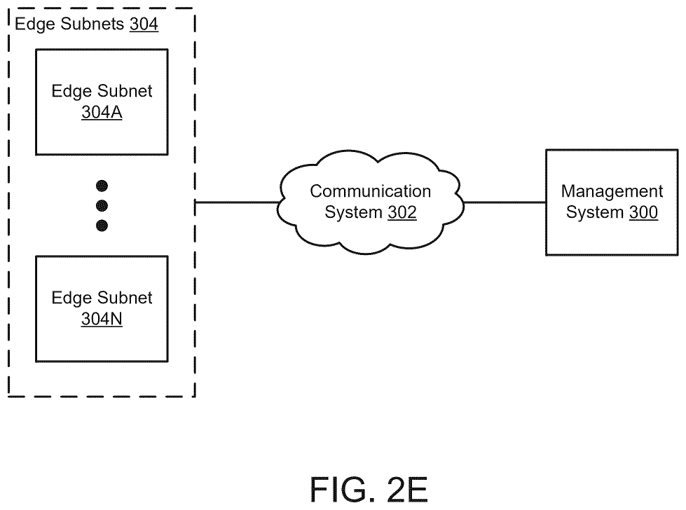

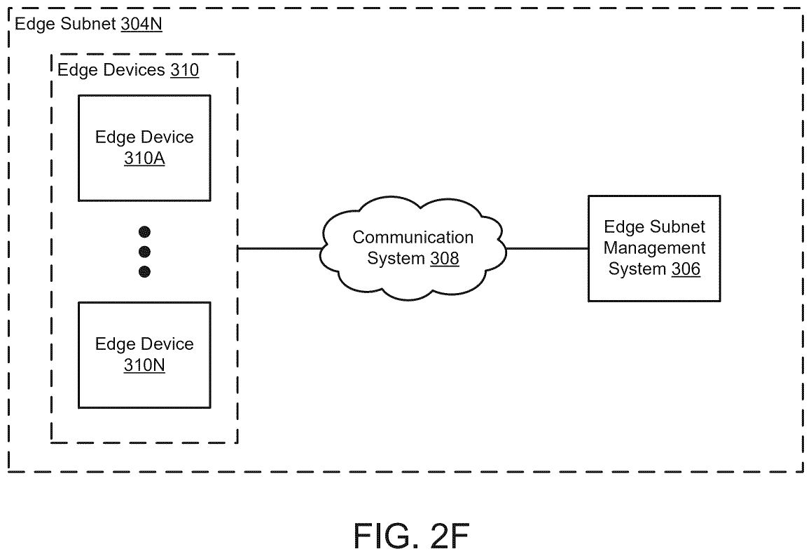

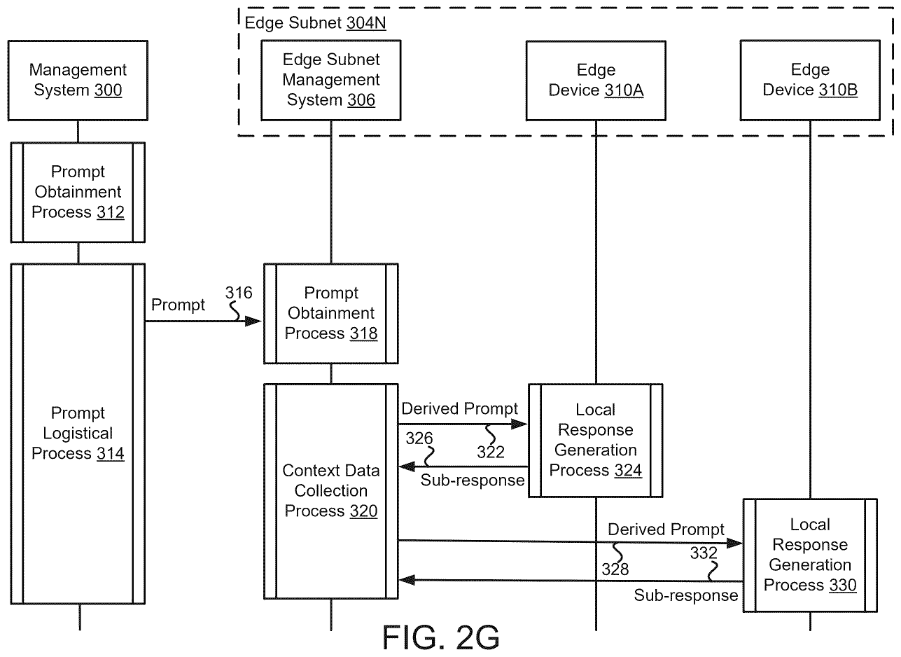

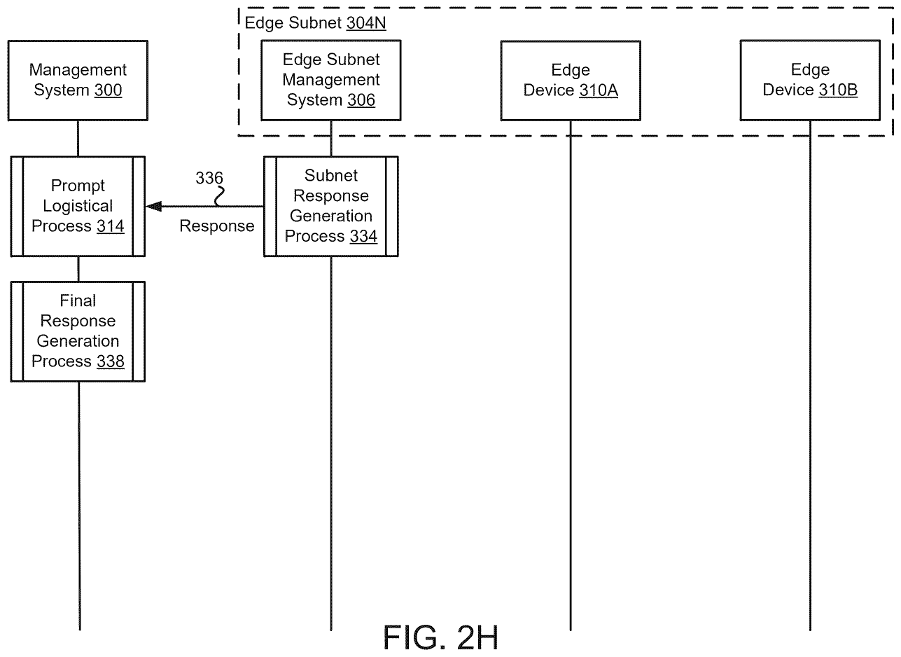

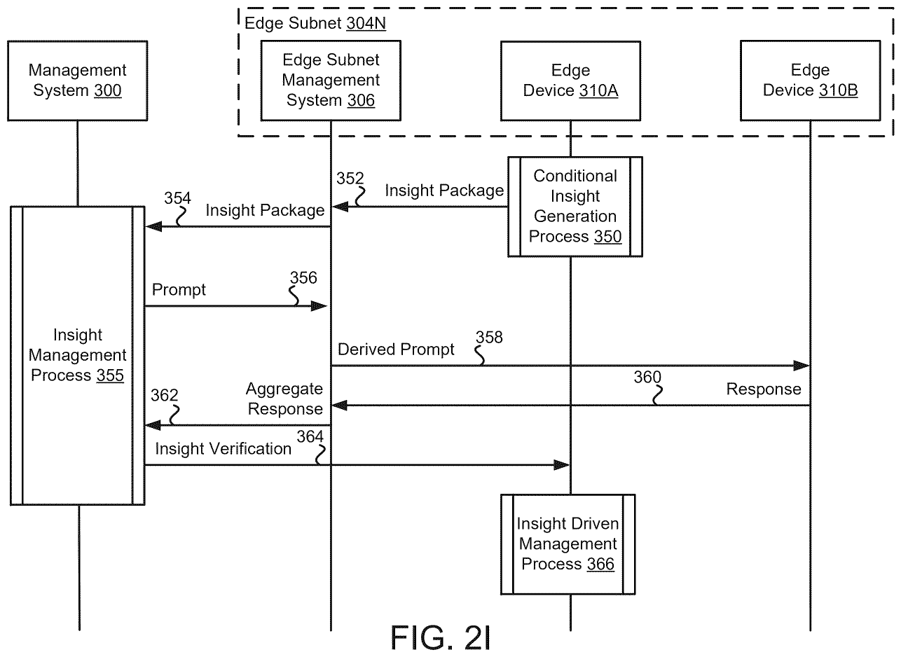

Training data sources 100A may include any number of data sources that provide training data for training of inference models. Training data sources 100A may include sources of raw data, processed data (e.g., curated data), and/or other types of data usable to train (e.g., retrain, fine-tune) the inference models. Refer to the discussion of FIG. 2A for more information regarding training of inference models.

Prompts 100B may include any volume and/or type of data for processing by the inference models. For example, prompts 100B may include any number of prompts obtained from consumers of inferences generated by the inference models (e.g., individuals, computers). Prompts 100B may include unstructured data and may be used, at least in part, to generate ingest data for inference models. For example, prompts 100B may include instances of ontology terms, and may undergo preprocessing to obtain sufficient context data for generating adequate ingest data. Refer to the discussion of FIGS. 2A-2B for more information regarding prompt preprocessing.

Knowledge data sources 100C may include any number and/or type of data sources that provide context data for prompts 100B. Knowledge data sources 100C may include a data source designated as a source of true data by an operator of inference models. Knowledge data sources 100C may be managed by the operator and/or another entity. For example, knowledge data sources 100C may include information regarding ontology terms included in ontology definitions defined by the operator and/or an organization of the operator and may be queried during preprocessing of a prompt of prompts 100B (e.g., during a retrieval process). Refer to the discussion of FIG. 2B for more information regarding use of knowledge data sources 100C.

Data sources 100 may include data repositories (e.g., training data repositories and/or knowledge data repositories, not shown), and may provide data to (e.g., allow access to data by) inference model manager 104.

Downstream consumers 102 may include any number and/or type of downstream consumers. For example, downstream consumers 102 may include individuals, organizations, and/or computers. Downstream consumers 102 may consume all, or a portion of the computer-implemented services. For example, downstream consumers 102 may include users of the managed data processing systems.

Downstream consumers 102 may consume all, or a portion of the inferences and/or output from downstream processes that use the inferences. For example, downstream consumers 102 may generate and/or provide prompts of prompts 100B (e.g., portions of ingest data) for processing by the inference models and may consume inferences generated by the inference models (e.g., in response to the ingest data) and/or output from the downstream processes that use the inferences. The inferences and/or output from the downstream processes may be used by downstream consumers 102 to improve decision-making and/or to automate tasks. For example, downstream consumers 102 may make decisions and/or initiate actions for managing operation of the data processing systems.

Inference model manager 104 may include any number of data processing systems and may manage any number of inference models. Inference model manager 104 may perform tasks relating to management of and/or facilitation of use of the inference models. For example, inference model manager 104 may manage (e.g., facilitate) (i) training processes for the inference models, (ii) preprocessing of prompts for the inference models, (iii) inferencing processes using the inference models (e.g., and the preprocessed prompts), (iv) downstream processes that use inferences obtained using the inference models, and/or (v) distribution of the inferences and/or output derived from the inferences to downstream consumers 102. Refer to the discussion of FIG. 2A for more details regarding operation of inference models.

To increase a likelihood of providing adequate ingest data to the inference models, inference model manager 104 may (i) obtain a prompt for an inference model (e.g., from prompts 100B), (ii) perform a first retrieval process for the prompt to obtain context data, (iii) analyze the context data based on ontology definitions to identify instances of ontology terms present in the prompt for which the context data does not meet sufficiency criteria, (iv) perform additional retrieval processes for the identified instances of ontology terms to obtain additional context data that meets the sufficiency criteria, and/or (v) obtain ingest data based on the prompt and/or the context data obtained during any of the performed retrieval processes. Refer to the discussion of FIG. 2B for an example of an ontology-based iterative retrieval process.

To facilitate management of operation of the data processing systems using inference models, inference model manager 104 may (i) use the ingest data to obtain a response (e.g., an inference) from an inference model, and/or (ii) use the response to provision desired computer-implemented services (e.g., distribute the response to downstream consumers 102 and/or by provide the response to downstream processes).

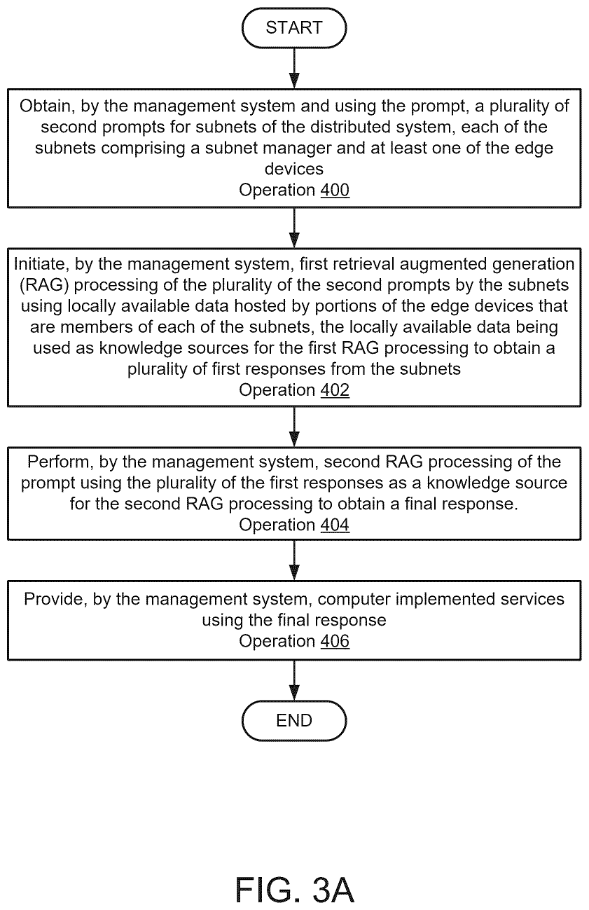

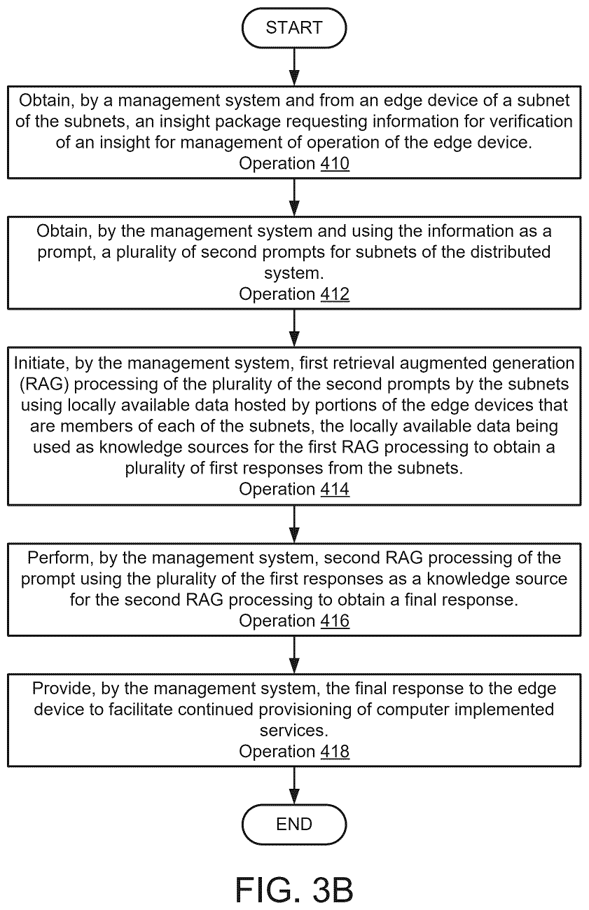

When providing their functionality, any of data sources 100, downstream consumers 102, inference model manager 104, and/or components thereof may perform all, or a portion of the actions and methods illustrated in FIGS. 2A-3B.

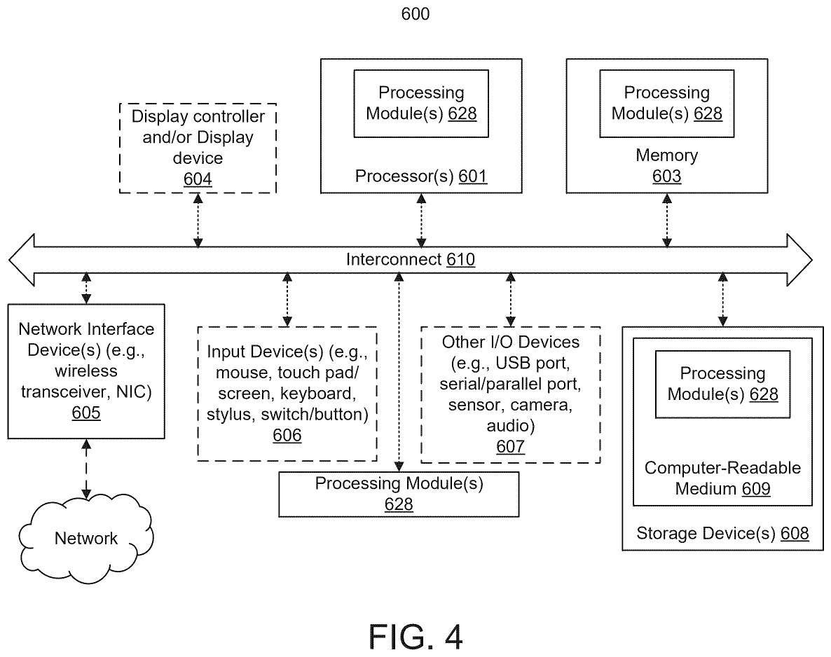

Any of data sources 100, downstream consumers 102, and inference model manager 104 may be implemented using a computing device (also referred to as a data processing system) such as a host or a server, a personal computer (e.g., desktops, laptops, and tablets), a “thin” client, a personal digital assistant (PDA), a Web enabled appliance, a mobile phone (e.g., smartphone), an embedded system, local controllers, an edge node, and/or any other type of data processing device or system. For additional details regarding computing devices, refer to the discussion of FIG. 4.

Any of the components illustrated in FIG. 1 may be operably connected to each other (and/or components not illustrated) with communication system 106. Communication system 106 may facilitate communications between the components of FIG. 1. In an embodiment, communication system 106 includes one or more networks that facilitate communication between any number of components. The networks may include wired networks and/or wireless networks (e.g., and/or the Internet). The networks and communication devices may operate in accordance with any number and types of communication protocols (e.g., such as the Internet protocol).

While illustrated in FIG. 1 as including a limited number of specific components, a system in accordance with an embodiment may include fewer, additional, and/or different components than those illustrated therein.

To further clarify embodiments disclosed herein, data flow diagrams in accordance with an embodiment are shown in FIGS. 2A-2B. In the diagram, flows of data and processing of data are illustrated using different sets of shapes. A first set of shapes (e.g., 200, 201) is used to represent data structures, a second set of shapes (e.g., 202, 212) is used to represent processes performed using and/or that generate data, and a third set of shapes (e.g., 100C) is used to represent sources of data.

Turning to FIG. 2A, a first data flow diagram in accordance with an embodiment is shown. The first data flow diagram may illustrate data used in and data processing performed when facilitating operation of an inference model. For example, the inference model may be used to manage operation of a data processing system.

In the example shown in FIG. 2A, operation of the inference model may include a training process and an inferencing process. The training process may include, for example, initial training of an (untrained) inference model, retraining of an inference model, and/or fine-tuning of an inference model. The inferencing process may include, for example, obtaining inferences using a trained inference model.

To obtain a trained inference model, a management entity (e.g., inference model manager 104) may facilitate performance of training process 202. Training process 202 may include training an untrained inference model defined by untrained model data 200.

Untrained model data 200 may include information relating to model architecture, hyperparameters, and/or other information regarding an untrained inference model (e.g., optimization algorithm information, hidden layer information, bias function descriptions, activation function descriptions, etc.). An inference model type and/or size may be selected based on performance goals and/or constraints, training data availability and/or quality, budget, timeline, etc. For example, the inference model may include a probabilistic model such as a generative machine-learning model (e.g., a large language model).

During training process 202, untrained model data 200 may be updated using training data 201. Training data 201 may be obtained from any number of data sources (e.g., training data sources 100A). For example, if the inference model is being trained to manage security for a data processing system, then the training data may include a corpus of information regarding types of security threats to the data processing system, labeled with actions for responding to the types of security threats (e.g., actions for reconfiguring security settings of the data processing system accordingly). As the inference model is exposed to large numbers of relationships and/or patterns in training data 201, weights and/or other parameters of untrained model data 200 may be modified to obtain trained model data 204.

Trained model data 204 may include inference model data (e.g., information regarding the architecture and/or hyperparameters of the inference model) and/or model parameter values of the inference model (e.g., weights). Trained model data 204 may be used during an inferencing process to generate inferences in response to ingest data, such as ingest data 210.

Ingest data 210 may include a portion of data for which an inference is desired to be obtained. For example, ingest data 210 may include prompt 206 (e.g., of prompts 100B). Prompt 206 may be obtained, for example, from a consumer of inferences and may include instances of ontology terms. To obtain ingest data 210 (e.g., an enhanced version of prompt 206), prompt 206 may undergo prompt preprocessing 208. For example, during prompt preprocessing 208, context data for ontology terms present in prompt 206 may be obtained and ingest data 210 may be generated based on prompt 206 and/or the context data. Refer to the discussion of FIG. 2B for more details regarding prompt preprocessing and/or obtaining ingest data 210.

Ingest data 210, along with trained model data 204, may be provided to inferencing process 212. During inferencing process 212, a trained inference model may be obtained based on information (e.g., node information, weight information, connection information, activation functions, attention mechanisms, etc.) included in trained model data 204. Ingest data 210 may not include labeled data and, thus, an association for ingest data 210 may not be known. During inferencing process 212, the trained inference model (e.g., a trained generative machine-learning model) may read ingest data 210 and respond with an output likely to be associated with the input (e.g., the trained inference model may generate an inference).

For example, ingest data 210 may include information regarding malicious code being executed by a component of a data processing system, and inference 214 may include actions for updating security settings of the data processing system that are likely to mitigate an outcome of the execution of the malicious code according to relationships and/or patterns learned by the inference model during training process 202. Inference 214 may be used to provision computer-implemented services. For example, inference 214 may be provided to downstream process 216, and downstream process 216 may include delivery of inference 214 to a downstream consumer (e.g., as a computer-implemented service), and/or further processing of inference 214.

For example, downstream process 216 may include any type of process for updating operation of the data processing system based on inference 214. For example, downstream process 216 may include a policy enforcement process, wherein security policies for the data processing system are enforced based on information included in inference 214 (e.g., actions, security and/or configuration settings) in order to mitigate outcomes associated with the execution of the malicious code. For example, operation of the data processing system may be updated to prevent access to sensitive data, to prevent network communication via components of the data processing system, and/or to disable operation of portions of components of the data processing system.

Although described with respect to security of the data processing system, it will be appreciated that the inference models may be trained and used to update operation of the data processing system in various capacities without departing from the embodiments disclosed herein. For example, the operation of the data processing system may be updated to improve user experience, to manage failures of components of the data processing system, to improve efficient allocation of resources (e.g., computing and/or power resources), and/or to meet other operational goals for the data processing system.

Thus, using the data flow shown in FIG. 2A, operation of a data processing system may be managed based on inferences generated by trained inference models. By doing so, operation of the data processing systems may be updated timely, and the data processing systems may be more likely to operate in a desired manner.

However, a quality (e.g., usability, reliability) of the inferences generated by the trained inference models may depend on a quality of ingest data to the trained inference models. Therefore, to increase a likelihood of the ingest data being of expected quality (e.g., having adequate informational content), ontology terms included in prompts for the trained inference models may be contextualized. Methods for obtaining context data for the prompts may be discussed with respect to FIG. 2B.

Turning to FIG. 2B, a second data flow diagram in accordance with an embodiment is shown. The second data flow diagram may illustrate data used in and data processing performed when obtaining ingest data for an inference model. FIG. 2B may be an example of prompt preprocessing 208 of FIG. 2A.

To obtain the ingest data, context data for prompt 206 may be retrieved from knowledge data sources 100C. Prompt 206 may include a submission to be processed by a trained inference model to facilitate provisioning of desired computer-implemented services by a data processing system. For example, prompt 206 may include information regarding operation of the data processing system.

To obtain the context data for prompt 206, retrieval process 220 may be performed. Retrieval process 220 may include any type of process(es) wherein information (e.g., terms) present in a prompt is identified, and additional information is retrieved from a data source based on the identified information. For example, retrieval process 220 may implement information retrieval methods used during retrieval-augmented generation process. During retrieval process 220, a prompt (e.g., prompt 206) may be obtained and used to generate a query (e.g., a keyword search query). The query may include, for example, search terms, search parameters, and/or other information. The query may then be used to search an external data source such as knowledge data sources 100C to identify responsive portions of data stored by the external data source.

As discussed with respect to FIG. 1, knowledge data sources 100C may include a data source designated as a source of true (e.g., trusted, reliable, relevant to a subject area) data by an operator of the inference model. For example, knowledge data sources 100C may include a number of chunks of data that are tagged to associate each of the number of chunks of data with ontology terms (and/or other searchable terms).

During a first performance of retrieval process 220, an original query may be generated based on prompt 206 (e.g., during the first performance of retrieval process 220, ontology terms may not be obtained from context data analysis process 222 as indicated by a respective arrow drawn in dashing). The original query may be derived from terms (e.g., words and/or phrases) present in prompt 206. The original query may be serviced using a deterministic process (e.g., using a trained deterministic inference model and/or any process that returns the same results for repeated servicing of the original query). For example, the original query may be used to identify portions of data responsive to the search terms and using the search parameters and/or instructions included in the original query from knowledge data sources 100C.

The identified portions of data responsive to the original query may then be ranked for relevance using a relevance ranking algorithm. Some number (e.g., best hits) of the ranked portions of data may then be selected for use as the context data. However, due to limitations of the relevance ranking algorithm and/or selection criteria, the selected context data may lack context for some terms present in the prompt such as those defined by ontology definitions 224. Therefore, to address these limitations of retrieval process 220, context data analysis process 222 may be performed.

During context data analysis process 222, context data obtained from retrieval process 220 may be analyzed using ontology definitions 224. Ontology definitions 224 may include, for example, a list (e.g., a table) of ontology terms. As discussed with respect to FIG. 1, the ontology terms may include words and/or phrases that have been designated as having a higher degree of meaning by an operator of the inference model than other words and/or phrases not designated as having the higher degree of meaning by the operator. For example, the ontology terms may include words and/or phrases that have different definitions in different subject areas.

During context data analysis process 222, first context data obtained from the first retrieval process may be evaluated to determine whether the first context data meets sufficiency criteria. The sufficiency criteria may specify a minimum level of content of context data with respect to ontology definitions 224. For example, instances of ontology terms specified by ontology definitions 224 that are present in prompt 206 may be identified, and levels of content of the first context related to each instance of the ontology terms may be identified. The levels of content may be compared to the minimum level of content to identify any instances of ontology terms for which the first context data does not meet the sufficiency criteria.

For example, the minimum level of content may specify, for each ontology term of ontology definitions 224 present in prompt 206, (i) a minimum number of words related to the respective ontology terms, (ii) a minimum number of chunks of data in the first context data that are tagged as related to the respective ontology terms, and/or (iii) a combination thereof.

The sufficiency criteria for the context data may be defined by policies. For example, the policies may specify a reduced number of ontology terms present in prompt 206 that are required to satisfy the minimum level of content, and/or an increased number of terms (e.g., other ontology terms defined by ontology definitions 224, other terms not defined by ontology definitions 224) beyond the ontology terms present in prompt 206 that are required to satisfy the minimum level of content. Any instances of ontology terms identified as present in prompt 206 that are not associated with context data satisfying at least the minimum level of content may be identified during context data analysis process 222.

If the first context data meets the sufficiency criteria for all ontology terms present in prompt 206, then the first context data may be included in all context data 226. However, if at least one instance of an ontology term may be identified for which the first context data does not meet the sufficiency criteria, then at least a portion of the first context data may be included in all context data 226 (e.g., the portion of the first context data that meet the sufficiency criteria).

In a first example, the at least one instance of the ontology term (e.g., shown as “ontology terms” in FIG. 2B) having insufficient context data may be provided to retrieval process 220 to initiate a second (iteration of) retrieval process 220 (e.g., ontology terms for which sufficient context data has been retrieved may not be included in the ontology terms provided to retrieval process 220.

In a second example, the ontology terms provided to retrieval process 220 may include all ontology terms identified in prompt 206, and each of the ontology terms may be tagged (e.g., via updating metadata) to indicate whether sufficient context data has been retrieved for each of the ontology terms. For example, the ontology term associated with the identified at least one instance may be tagged as being associated with insufficient context data, while other ontology terms may be tagged as being associated with sufficient context data.

Note that the arrow indicating the ontology terms are provided to retrieval process 220 is drawn in dashing to indicate that under some conditions the ontology terms may not be provided to retrieval process 220 (e.g., during a first iteration of retrieval process 220 and/or during subsequent iterations of retrieval process 220 when retrieved context data meets the sufficiency criteria for all ontology terms present in prompt 206).

During the second retrieval process, a revised query may be derived using the ontology terms obtained from context data analysis process 222. For example, the revised query may only include ontology terms that are tagged as associated with insufficient context data. The revised query may include a reduced number of ontology terms specified by the ontology definitions when compared to a number of ontology terms specified by the original query. The reduced number of ontology terms may include the ontology term (e.g., for which the at least one instance of the ontology term was identified), and may exclude a second ontology term of ontology definitions 224 for which an instance of the second ontology term is present in prompt 206 and for which the first context data meets the sufficiency criteria (e.g., the second ontology term having been included in the original query).

Consider a security example where a prompt, “Program A is being executed by component C of data processing system D, using resources Q, and is accessing file F,” is provided to retrieval process 220. During the first retrieval process, “A,” “C,” “D,” and “F” may include ontology terms specified by ontology definitions 224. The ontology terms may be identified and used to obtain the original query. Therefore, the original query may include 4 ontology terms specified by ontology definitions 224.

During the first retrieval process, knowledge data sources 100C may return sufficient context data for “A” “C”, and “D”, but not “F”. Therefore, during context data analysis process 222, “F” may be identified as not being associated with at least the minimum level of content specified by the sufficiency criteria. Therefore, context data analysis process 222 may provide a data package including “F” (and excluding “A”, “C”, and “D”, for which sufficient context data has already been obtained) to retrieval process 220, and a second retrieval process may be performed. The second retrieval process may use a revised query that includes 1 ontology term specified by ontology definitions 224 (e.g., “F”).

Returning to the second retrieval process, the revised query may be used to retrieve second context data from knowledge data sources 100C. By using the revised query, the search algorithm used during retrieval process 220 may be more likely to rank and select sufficient context data for the ontology terms included in the revised query compared to when using the original query.

The second context data may be provided to context data analysis process 222, and a determination may be made regarding whether the second context data meets the sufficiency criteria. If the second context data meets the sufficiency criteria, then the second context data may be included in all context data 226. However, if the second context data does not meet the sufficiency criteria, then at least a portion of the second context data may be included in all context data 226, and context data analysis process 222 may be performed to identify ontology terms for which the second context data is insufficient. Iterations of retrieval process 220 and/or context data analysis process 222 may be performed until all context data 226 meets the sufficiency criteria for each instance of ontology terms present in prompt 206.

All context data 226 may include context data retrieved during any number of iterations of retrieval process 220. All context data 226 may be used, in part, to obtain ingest data 210. For example, ingest data 210 may include all context data 226 (e.g., the first context data and/or the second context data) and/or prompt 206. Ingest data 210 may be provided to an inferencing process so that a response (e.g., an inference) may be obtained using a trained inference model. For example, ingest data 210 may be provided to inferencing process 212 of FIG. 2A.

Returning to the security example, the response obtained from the inference model (e.g., inference 214 in FIG. 2A) during the inferencing process may indicate that program A is likely to include malicious code, and that file F is not expected to be accessed by program A during desired operation of data processing system D. The response may indicate that a security policy for data processing system D should be enforced (e.g., which may occur during downstream process 216 of FIG. 2A).

Any of the processes illustrated using the second set of shapes may be performed, in part or whole, by digital processors (e.g., central processors, processor cores, etc.) that execute corresponding instructions (e.g., computer code/software). Execution of the instructions may cause the digital processors to initiate performance of the processes. Any portions of the processes may be performed by the digital processors and/or other devices. For example, executing the instructions may cause the digital processors to perform actions that directly contribute to performance of the processes, and/or indirectly contribute to performance of the processes by causing (e.g., initiating) other hardware components to perform actions that directly contribute to the performance of the processes.

Any of the processes illustrated using the second set of shapes may be performed, in part or whole, by special purpose hardware components such as digital signal processors, application specific integrated circuits, programmable gate arrays, graphics processing units, data processing units, and/or other types of hardware components. These special purpose hardware components may include circuitry and/or semiconductor devices adapted to perform the processes. For example, any of the special purpose hardware components may be implemented using complementary metal-oxide semiconductor-based devices (e.g., computer chips).

Any of the data structures illustrated using the first set of shapes may be implemented using any type and number of data structures. Additionally, while described as including particular information, it will be appreciated that any of the data structures may include additional, less, and/or different information from that described above. The informational content of any of the data structures may be divided across any number of data structures, may be integrated with other types of information, and/or may be stored in any location.

Thus, using the data flow shown in FIG. 2B, a quality of ingest data to inference models may be improved using context data obtained via an iterative retrieval process. The iterative retrieval process may be more likely to produce sufficient context data for instances of ontology terms present in prompts submitted for processing by the inference models. By doing so, inferences obtained based on the ingest data may be more likely to be reliable for managing operation of data processing systems, and the data processing systems may be more likely provide desired computer-implemented services.

While specific context data analysis and retrieval processes are shown and discussed with regard to FIG. 2B, it will be appreciated that other processes regarding context data collection may be used without departing from embodiments discussed herein.

Turning to FIG. 2C, a block diagram illustrating a second distributed system in accordance with an embodiment is shown. The system shown in FIG. 2C may provide computer-implemented services similar to the first distributed system shown and discussed with regard to FIG. 1. It will be appreciated, however, that in the discussion of FIG. 1 an inference model tasked with servicing the prompt may be able to access a trusted knowledge base that may include sufficient context data. The inference model may then ingest this sufficient context data to output a final response that when used has an increased likelihood of initiating desired operation of data processing systems within the first distributed system.

In contrast, the following discussion of FIG. 2C may regard a second distributed system in which the inference model tasked with servicing the prompt may be unable to access a trusted knowledge base that may include the sufficient context data. In such cases, the previously discussed edge-augmented generation process may be facilitated by the second distributed system (e.g., as shown in FIG. 2C) and/or components thereof to provide the computer-implemented services.

As previously discussed in FIG. 1, the computer-implemented services may include any type and quantity of computer-implemented services. The computer-implemented services may be provided by data processing systems to consumers of the computer-implemented services based on an operation of the second distributed system of which the data processing systems may be a part. To provide the computer-implemented services as desired by a downstream consumer of the services, operation of the data processing systems (e.g., operation of the second distributed system) may be managed. The operation may be managed using artificial intelligence. For example, (trained) inference models may be used to assess, predict, and/or otherwise manage occurrences of events that may negatively impact provisioning of the computer-implemented services as desired by providing useful final responses. Also, as previously discussed, to increase a likelihood of generating reliable responses during inferencing, a retrieval-augmented generation (RAG) process may be implemented to improve informational content of the ingest data to the inference models. To do so, the prompt may undergo preprocessing, during which context data may be obtained for terms present in the prompt.

However, trusted knowledge bases with a high likelihood of storing desirable context data for servicing the prompt may not be accessible to the inference model tasked with the servicing of the prompt. Such trusted knowledge bases may instead be subject to limited accessibility. One of such trusted knowledge bases may, for example, only be accessible by an individual edge device.

In general, embodiments disclosed herein may provide methods, systems, and/or devices for managing operation of a distributed system using a distributed generative inference model pipeline. The distributed generative inference model pipeline may facilitate acquisitions and use of information stored in disparate locations across the system shown in FIG. 2C. The collected information may, for example, enable expected quality (e.g., adequate) ingest data (for generative models) to be obtained and used by management system 234.

The generative inference model pipeline may include multiple instances of inference models hosted by different components of the system. The different components of the system may have access to different local information.

Some of the instances of the inference models may use the local information as a RAG data sources, while other instances of the inference models may use remote instances of inference models as RAG data sources. For example, management system 234 may use edge devices 230 as RAG data sources, while each of edge devices 230 may use the local information available to them as the RAG data sources.

When a request for management system 234 is obtained, the request may be treated as an initial prompt. To service the initial prompt, management system 234 may generate and distribute prompts to any of edge devices 230 in an attempt to obtain responses usable as context data for the initial prompt. The initial prompt and resulting context data may be input to the inference model hosted by management system 234 to obtain a final response. The final response may be used to service the request, and/or provide other services for a downstream process/consumer during/for which operation of a data processing system may be updated.

To obtain the responses, second prompts may be provided to edge devices with access to trusted knowledge bases where required context data may be stored. The trusted knowledge bases (e.g., local information) being inaccessible to, for example, the management system. By providing the second prompts, the edge devices may utilize respectively hosted inference models of their own to ingest a copy of the second prompts along with retrieved context data from the local information. In doing so, first responses may be output by these inference model that may then be provided to, for example, the management system.

To obtain the final response, the first responses (e.g., used as context data) may be used as ingest, along with the initial prompt (e.g., provided by a downstream consumer), for the inference model hosted by the management system. Such ingestion may result in the inference model hosted by the management system outputting the final response. The final response may then be used to initiate update of the system, or perform other processes (e.g., which may depend on the request originally obtained by the system).

By doing so, operation of the distributed system may be managed without requiring a centralized source of information. Accordingly, data collection processes such as telemetry data collection may not need to be performed by management system 234 to manage operation of the distributed system. Accordingly, the computational overhead for data collection, processing, and storage may be avoided. In many example cases, most collected information may not ever be used thereby rendering the computational expenditures in collecting and aggregating such information to be of little to no value to the operation of the system. Thus, the disclosed system may reduce computational overhead for managing operation of the system.

To provide the above-mentioned functionality, the second distributed system of FIG. 2C may include edge devices 230, management system 234, and communication system 106. The second distributed system, any components thereof, and/or any other types of devices or components not shown in FIG. 2C may perform all, or a portion of the computer-implemented services independently and/or cooperatively. Each of these components is discussed below with the exception of communication system 106 due to being previously discussed with regard to FIG. 1.

Management system 234 may generally manage the operation of the system of FIG. 2C. For example, management system 234 may receive requests, instructions, etc. to be performed with respect to components of the system. To service the requests, instructions, etc., management system 234 may use the distributed generative inference model pipeline, as discussed above.

Edge devices 230 may provide any number and type of computer implemented services and be managed by management system 234. During such management, edge devices 230 may participate in the distributed generative inference model pipeline. For example, each of these edge devices may include access to a local database that (i) is inaccessible to management system 234, and (ii) may include stored data regarding its host that may be beneficial to contribute to (directly and/or indirectly) context data for servicing the initial prompt. The local database may include information such as, for example, logs of operation of the system, issues impacting the respective edge devices, locally collected and/or generated information (e.g., sensor measurements, derived information from the sensor measurements, etc.), and/or any other type of local information obtained and/or generated by the edge device (and/or information provided to it by other devices).

For additional information regarding operation of inference models, refer back to FIG. 2A. For additional information regarding distributed generative inference model pipelines and operation thereof as part of the system shown in FIG. 2C, refer to FIGS. 2D-3B.

When providing their functionality, any of edge devices 230, management system 234, and/or components thereof may perform all, or a portion of the actions and methods illustrated in FIGS. 2A-3B.

Any of edge devices 230 and management system 234 may be implemented using a computing device (also referred to as a data processing system) such as a host or a server, a personal computer (e.g., desktops, laptops, and tablets), a “thin” client, a personal digital assistant (PDA), a Web enabled appliance, a mobile phone (e.g., smartphone), an embedded system, local controllers, an edge node, and/or any other type of data processing device or system. For additional details regarding computing devices, refer to the discussion of FIG. 4.

Any of the components illustrated in FIG. 2C may be operably connected to each other (and/or components not illustrated) with communication system 106. Communication system 106 may facilitate communications between the components of FIG. 2C as discussed with regard to FIG. 1. As previously discussed, communication system 106 may include one or more networks that facilitate communication between any number of components. The networks may include wired networks and/or wireless networks (e.g., and/or the Internet). The networks and communication devices may operate in accordance with any number and types of communication protocols (e.g., such as the Internet protocol).

While illustrated in FIG. 2C as including a limited number of specific components, a system in accordance with an embodiment may include fewer, additional, and/or different components than those illustrated therein.

To further clarify embodiments disclosed herein, an interaction diagram in accordance with an embodiment is shown in FIG. 2D. This interaction diagram may illustrate how data may be obtained and used within the systems of FIGS. 1 and 2C.

In the interaction diagram, processes performed by and interactions between components of a system in accordance with an embodiment are shown. In the diagrams, components of the system are illustrated using a first set of shapes (e.g., 234, 232A, etc.), located towards the top of FIG. 2D. Lines descend from these shapes. Processes performed by the components of the system are illustrated using a second set of shapes (e.g., 242, 251, etc.) superimposed over these lines. Interactions (e.g., communication, data transmissions, etc.) between the components of the system are illustrated using a third set of shapes (e.g., 250, 262, etc.) that extend between the lines. The third set of shapes may include lines terminating in one or two arrows. Lines terminating in a single arrow may indicate that one-way interactions (e.g., data transmission from a first component to a second component) occur, while lines terminating in two arrows may indicate that multi-way interactions (e.g., data transmission between two components) occur.

Generally, the processes and interactions are temporally ordered in an example order, with time increasing from the top to the bottom of each page. For example, the interaction labeled as 250 may occur prior to the interaction labeled as 252. However, it will be appreciated that the processes and interactions may be performed in different orders, any may be omitted, and other processes or interactions may be performed without departing from embodiments disclosed herein.

Turning to FIG. 2D, an interaction diagram in accordance with an embodiment is shown. The interaction diagram may illustrate processes and interactions that may occur during management of a distributed system. For example, such management may be performed, at least in part, by a management system (e.g., 234).

To manage the distributed system, a distributed generative inference model pipeline may be used as discussed above with regard to FIG. 2C. In doing so, an edge-augmented generation process may be performed. During this edge-augmented generation process, (i) a prompt obtainment process may be performed (e.g., 241), (ii) a context data collection process may be performed (e.g., 242), (iii) a final response generation process may be performed (e.g., 282), and/or (iv) other processes may be performed, not to be limited by embodiment discussed herein.

For example, to manage the distributed system, management system 234 may perform prompt obtainment process 241 as shown in FIG. 2D,

During prompt obtainment process 241, (i) a prompt may be submitted for processing by a first generative trained machine learning model, (ii) a determination may be made regarding whether there is access to information that may be relevant to the prompt, or whether there is a lack of sufficient information regarding edge devices of the distributed system to service the prompt (e.g., serviced by management system 234).

Assume that (i) the first generative trained machine learning model is hosted by management system 234 and (ii) the prompt may be obtained as an outcome of any number of processes/operations. For example, the prompt may be (i) provided by a user based on the user's interaction with the distributed system via a user interface (UI), (ii) generated by software hosted by management system 234 as a result of management system 234's operation, and/or (iii) any other type and/or quantity of processes/operations not to be limited by embodiments discussed herein.

For example, such a prompt may include (e.g., assuming that the prompt is based on the previously mentioned user interaction via a UI) a string of text such as (i) “are any of my hardware components overheating?” Or another string of text that may require analysis of higher complexity, thereby promoting responses more likely to be intuitive as a result, such as (ii) “how did the overheating policies in my devices affect system performance last summer?” The determination that there is the lack of the sufficient information to service the prompt may be based on, for example, management system 234 not having access to local and respective databases of various edge devices whose respective hardware components'operating states (e.g., during “last summer”) the prompt may, for example, indicate as being required telemetry information of the edge devices.

Based on this determination, context data collection process 242 may be performed to obtain context data for attempting to increase a quality of an output from the first generative trained machine learning model that is based on the prompt. During context data collection process 242, (i) a plurality of second prompts may be obtained, (ii) a copy of at least one second prompt of the plurality of second prompts may be provided to one of the edge devices, (iii) it may be indicated to the one of the edge devices that the at least one second prompt is to be processed to obtain one first response (that may in some cases be of a plurality of first responses) and that the one first response is to be provided to the management system, (iv) obtaining either the plurality of the first responses, or in cases where there may be only one edge device, the one first response, and/or (v) other processes may be performed, not to be limited by embodiments discussed herein.

It will be appreciated that the examples discussed below are discussed based on an assumption that there is more than one edge device whose telemetry data is indicated by the prompt as being desirable (and/or required) to service the prompt.

To obtain the plurality of second prompts, the first generative trained machine learning model of management system 234 (and/or another inference model of management system 234) may generate an output to be used as the plurality of second prompts based on (i) the prompt, (ii) the type and/or quantity of the plurality of edge devices, and/or (iii) other information not to be limited by embodiments discussed herein. Copies of the at least one second prompt may thus be provided to each of the various edge devices (e.g., 232A-232C). For example, during context data collection process 242, interactions 250-272 may be performed where such copies are provided, and such first responses are obtained.

For example, at interaction 250, a prompt (e.g., a copy of the at least one second prompt) may be provided to edge device 232A by management system234. In doing so, it may be indicated to edge device 232A that this copy of (and/or an otherwise derivative of) the at least one second prompt requires processing to obtain the one first response. this copy of a second prompt may be generated and provided to edge device 232A by (i) transmission via a message, (ii) storing in a storage with subsequent retrieval by edge device 232A, and/or (iii) via other processes not to be limited by embodiments discussed herein. By providing the second prompt to edge device 232A, edge device 232A may be capable of providing the one first response to management system 234 as discussed below.

To provide the one first response, edge device 232A may perform local response generation process 251. During local response generation process 251, (i) the copy of the at least one second prompt may be obtained as shown with interaction 250, (ii) the obtained second prompt may be used as input for an inference model locally hosted by edge device 232A while local storage (e.g., a local database) of edge device 232A may be accessed to retrieve relevant information that may also be used as input for the inference model along with the obtained second prompt, (iii) the one first response may be obtained as output from the inference model based on the input, and (iv) the one first response may be provided to management system 234.

For example, the retrieved information may be telemetry data specifying an operating state of edge device 232A, this telemetry data being inaccessible to management system 234. For example, such telemetry data may include ongoing operations performed by respective components of edge device 232A along with a respective temperature for each of the components. This telemetry data may therefore be used as input for, along with the at least one second prompt, processing by the inference model hosted by edge device 232A. Based on this input, an output may be obtained and used as the one first response. For example, the one first response may be a string of text (e.g., similar to the prompt and/or the second prompt) such as “edge device 232A's processor is overheating.”

At interaction 252, a response (e.g., the one first response) may be provided to management system 234 by edge device 232A. In doing so, management system 234 may obtain additional context data to be ingested with the (initial) prompt to attempt at increasing a quality of inferences made (e.g., output) to service the prompt, the additional context data including the plurality of first responses.

It will be appreciated that interactions 260-262 and 270-272 are the copies of the at least one second prompt and corresponding first responses respectively sent to, and obtained from, other edge devices, edge device 232B and edge device 232C. For example, upon each obtaining a copy of the at least one second prompt via interactions 260 and 270, local response generation process 261 and local response generation process 271 may be respectively performed by edge device 232B and edge device 232C. However, based on these processes being similar to that performed by edge device 232A (e.g., process 251), these processes may differ in that each edge device may utilize their own locally hosted inference models and databases to obtain respective first responses that are relevant to the respective edge devices. Additionally, it will be appreciated that these local databases and/or inference models may be inaccessible to management system 234, as previously discussed.

By performing these processes, the edge devices may collectively provide the plurality of first responses to management system 234, concluding performance of context data collection process 242. Once sufficient context data is obtained by performing context data collection process 242, final response generation process 282 may be performed.

During final response generation process 282, (i) the plurality of the first responses may be used as ingest, along with the original prompt provided by the user, for the first generative trained machine learning model (e.g., the inference model hosted by management system 234), (ii) an output may be obtained from the inference model, the output being the final response to service the prompt, and (iii) the providing of computer implemented services based on the final response may be initiated.

For example, the final response may include a string of text such as “edge device 232A is overheating” (assuming that the other edge devices had first responses that indicated respective temperatures and operation that, for simplicity, are considered ideal). Therefore, services initiated by the final response may include increasing fan rotations per minute to attempt to increase cooling of edge device 232A.

Turning to FIGS. 2E-2F, block diagrams illustrating a third distributed system in accordance with an embodiment is shown. The system shown in FIGS. 2E-2F may provide computer-implemented services similar to the first distributed system shown and discussed with regard to FIG. 1 and/or similar to the second distributed system shown and discussed with regard to FIG. 2C.

It will be appreciated, however, that in the discussion of FIG. 1 an inference model tasked with servicing the prompt may be able to access a trusted knowledge base that may include sufficient context data. The inference model may then ingest this sufficient context data to output a final response that when used has an increased likelihood of initiating desired operation of data processing systems within the first distributed system. Further, the discussion of FIG. 2C may regard the second distributed system in which the inference model tasked with servicing the prompt may be unable to access a trusted knowledge base that may include the sufficient context data. Instead, the prompt may be serviced using local information that includes the sufficient context data from at least one edge device of the second distributed system. The local information may be ingested by the inference model of the at least one edge device to generate first responses. The first responses may be transmitted to the management system and/or ingested by a second inference model of the management system to generate the final response.

In contrast, the following discussion of FIGS. 2E-2F may regard the third distributed system in which the inference model tasked with servicing the prompt may (i) be unable to access a trusted knowledge base that may include the sufficient context data and/or (ii) include at least one subnet that includes the at least one edge device. In such cases, the previously discussed edge-augmented generation process may be facilitated by the third distributed system (e.g., as shown in FIGS. 2E-2F) and/or components thereof to provide the computer-implemented services.

As previously discussed in FIG. 1, the computer-implemented services may include any type and quantity of computer-implemented services. The computer-implemented services may be provided by data processing systems to consumers of the computer-implemented services based on an operation of the third distributed system of which the data processing systems may be a part. To provide the computer-implemented services as desired by a downstream consumer of the services, operation of the data processing systems (e.g., operation of the third distributed system) may be managed. The operation may be managed using artificial intelligence. For example, (trained) inference models may be used to assess, predict, and/or otherwise manage occurrences of events that may negatively impact provisioning of the computer-implemented services as desired by providing useful final responses. Also, as previously discussed, to increase a likelihood of generating reliable responses during inferencing, a retrieval-augmented generation (RAG) process may be implemented to improve informational content of the ingest data to the inference models. To do so, the prompt may undergo preprocessing, during which context data may be obtained for terms present in the prompt.

However, trusted knowledge bases with a high likelihood of storing desirable context data for servicing the prompt may not be accessible to the inference model tasked with the servicing of the prompt. Such trusted knowledge bases may instead be subject to limited accessibility and/or a layered architecture of the third distributed system. One of such trusted knowledge bases may, for example, only be accessible by an individual edge device that is included in a subnet of at least one subnet of edge devices.

In general, embodiments disclosed here relate to systems and methods for provide methods, systems, and/or devices for managing operation of a distributed system using a distributed generative inference model pipeline. The operation may be managed by (i) obtaining, by the management system and using a prompt, a plurality of second prompts for subnets of the third distributed system, (ii) initiating, by the management system, first retrieval augmented generation (RAG) processing of the plurality of the second prompts by the subnets using local information hosted by the at least one edge device of the at least one subnet to obtain a plurality of first responses from the subnets, (iii) performing, by the management system, second RAG processing of the prompt using the plurality of the first responses, and/or (iv) providing, by the management system, the computer implemented services using the final response.

The plurality of the second prompts may be obtained by generating, by the management system, the second prompts using the prompt. The second prompts may be derived by (i) performing at least one modification, based on at least one attribute and/or at least one capability of at least one edge device of the at least one subnet, to information of the prompt and/or (ii) generating, using the at least one modification of the information, the second prompts. The at least one attribute and/or the at least one capability of the edge devices of the at least one subnet may include (i) system usage data (e.g., memory usage, network traffic, input/output operations, etc.), (ii) environmental ambient conditions (e.g., temperature data, humidity data, air pressure data, dust and/or dirt exposure data, heat generation data, heat dissipation data, etc.), (iii) threat assessments (e.g., data regarding physical tampering, the data regarding network security, data breaches, etc.), (iv) any other attributes reflective of any other conditions of the at least one edge device. The at least one capability may include (i) data collections (e.g. environmental sensing, location tracking, etc.), (ii) data transmission (e.g., multi-channel communications, mesh networking, etc.), (iii) sensing capabilities (e.g., motion sensing, optical sensing, acoustic sensing, etc.), (iv) any other capability used in operation of the at least one edge device.

The first RAG processing of the plurality of the second prompts may be initiated by (i) transmitting the second prompts to the at least one subnet, (ii) transmitting, by a subnet manager of the at least one subnet, a second prompt of the second prompts to the at least one edge device of the at least one subnet, (iii) performing, by the at least one edge device, the first RAG processing to generate at least one first response, and/or (iv) obtaining, by the subnet manager, the at least one first response of the at least one edge device to generate the plurality of the first responses. The subnet manager may manage the operation of the at least one edge device. The subnet manager may (i) distribute the second prompts to the at least one edge device, (ii) modify a second prompt of the second prompts before the distribution of the second prompt based on, for example, the at least one attribute and/or at least one capability of the at least one edge device, (iii) retrieve the at least one first response by the at least one edge device to the second prompt to generate the plurality of the first responses, (iv) rank order the plurality of the first responses of the at least one first response based on any magnitude of first relevance to at least the second prompt and/or the prompt, (v) transmit at least a portion of the plurality of the first responses to the management system, etc. A first subnet manager may utilize a first ranking criteria of the plurality of the first responses that is different and/or similar than a second ranking criteria of a second subnet manager.

The second RAG processing may be performed, by the management system, by (i) receiving, from the subnet manager of the at least one subnet, the at least the portion of the plurality of the first responses and/or (ii) generating the final response using a trained generative inference model. The generative trained inference model may include a large language model (LLM), a small language model (SLM), etc.

The final response may be used to provide computer implemented services. The final response may include, for example, (i) a notification of, for example, an anomaly, critical event, etc., (ii) a recommendation for, for example, maintenance, optimization, configuration change, etc. (iii) a result of at least one scenario based on, for example, performance data and/or user interactions, etc. The final response may be used by providing information from (i) the notification, (ii) the recommendation, (iii) the result, etc. in a plan to (i) maintain, (ii) optimize, (iii) remediate, etc. at least one data processing system that is used to provide computer implemented services.

To provide the above-mentioned functionality, the third distributed system of FIGS. 2E-2F may include management system 300, edge subnets 304, edge subnet management system 306, edge devices 310, communication system 302, and communication system 308. The third distributed system, any components thereof, and/or any other types of devices or components not shown in FIGS. 2E-2F may perform all, or a portion of the computer-implemented services independently and/or cooperatively. Each of these components is discussed below. However, communication system 302 and/or communication system 308 may be similar to communication system 106. Therefore the description of communication 106, which was previously discussed with regard to FIG. 1, may apply to communication system 302 and/or communication system 308.

Management system 300 may generally manage the operation of the system of FIGS. 2E-2F. For example, management system 300 may receive requests, instructions, etc. to be performed with respect to components of the system. To service the requests, instructions, etc., management system 300 may use the second trained generative inference model, as discussed above.

Edge devices 310 may provide any number and type of computer implemented services and/or be managed by management system 300. During such management, edge devices 310 may participate in a distributed generative inference model pipeline. For example, each of these edge devices may include access to a local database that (i) is inaccessible to management system 300, and (ii) may include stored data regarding its host that may be beneficial to contribute to (directly and/or indirectly) context data for servicing the initial prompt. The local database may include information such as, for example, logs of operation of the system, issues impacting the respective edge devices, locally collected and/or generated information (e.g., sensor measurements, derived information from the sensor measurements, etc.), and/or any other type of local information obtained and/or generated by the edge device (and/or information provided to it by other devices).

Edge subnets 304 may include edge subnet 304A-304N. An edge subnet (e.g., edge subnet 304N) may include at least a portion of edge devices (e.g., edge devices 310A-310N) and/or an edge subnet management system (e.g., edge subnet management system 306). The edge subnet (e.g., 304N) may include (i) network segmentation (e.g., a defined range of internet protocol addresses), (ii) resource allocation (e.g., load balancing of workloads), (iii) redundancy measures (e.g., backup devices to maintain data integrity and/or data availability), (iv) operational diversity (e.g., inclusion and/or utilization of various sensors (e.g., temperature, motion, imaging, etc.)), etc.

The edge subnet management system (e.g., edge subnet management system 306) may be used to manage operation of the at least the portion of edge devices (e.g., edge devices 310A-310N) of the edge subnet (e.g., edge subnet 304N). The edge subnet management system may manage the at least the portion of edge devices by (i) distributing prompts to the at least one edge device, (ii) modifying a prompt of the prompts before the distribution of the prompt based on, for example, at least one attribute and/or at least one capability of at least one edge device of the at least the portion of the edge devices, (iii) retrieving a first response by the at least one edge device to the prompt to generate a plurality of the first responses, (iv) rank ordering the plurality of the first responses based on any magnitude of first relevance to at least the prompt, (v) transmitting at least a portion of the plurality of the first responses to the management system (e.g., 300), (vi) any other action that engages operation of the at least the portion of edge devices and/or utilizes data provided by the at least the portion of edge devices.

While providing their functionality, any of management system 300, edge subnets 304, edge subnet management system 306, and/or edge devices 310 may perform all, or a portion, of the flows, interactions, and methods shown in FIGS. 2G-3B.

Any of (and/or components thereof) management system 300, edge subnets 304, edge subnet management system 306, and/or edge devices 310 may be implemented using a computing device (also referred to as a data processing system) such as a host or a server, a personal computer (e.g., desktops, laptops, and tablets), a “thin” client, a personal digital assistant (PDA), a Web enabled appliance, a mobile phone (e.g., Smartphone), an embedded system, local controllers, an edge node, and/or any other type of data processing device or system. For additional details regarding computing devices, refer to FIG. 4.

Any of the components illustrated in FIGS. 2E-2F may be operably connected to each other (and/or components not illustrated) with communication system 308. In an embodiment, communication system 308 includes one or more networks that facilitate communication between any number of components. The networks may include wired networks and/or wireless networks (e.g., and/or the Internet). The networks may operate in accordance with any number and types of communication protocols (e.g., such as the Internet protocol).

While illustrated in FIGS. 2E-2F as including a limited number of specific components, a system in accordance with an embodiment may include fewer, additional, and/or different components than those components illustrated therein.

To further clarify embodiments disclosed herein, interactions diagrams in accordance with an embodiment are shown in FIGS. 2G-2I. These interactions diagrams may illustrate how data may be obtained and used within the system of FIGS. 2G-2I.

In the interaction diagrams, processes performed by and interactions between components of a system in accordance with an embodiment are shown. In the diagrams, components of the system are illustrated using a first set of shapes (e.g., 300, 306, etc.), located towards the top of each figure. Lines descend from these shapes. Processes performed by the components of the system are illustrated using a second set of shapes (e.g., 312, 314, etc.) superimposed over these lines. Interactions (e.g., communication, data transmissions, etc.) between the components of the system are illustrated using a third set of shapes (e.g., 316, 326, etc.) that extend between the lines. The third set of shapes may include lines terminating in one or two arrows. Lines terminating in a single arrow may indicate that one way interactions (e.g., data transmission from a first component to a second component) occur, while lines terminating in two arrows may indicate that multi-way interactions (e.g., data transmission between two components) occur.

Generally, the processes and interactions are temporally ordered in an example order, with time increasing from the top to the bottom of each page. For example, the interaction labeled as 316 may occur prior to the interaction labeled as 326. However, it will be appreciated that the processes and interactions may be performed in different orders, any may be omitted, and other processes or interactions may be performed without departing from embodiments disclosed herein.

Turning to FIG. 2G, a second interaction diagram in accordance with an embodiment is shown. The second interaction diagram may illustrate data used in and data processing performed in receiving a first response (e.g., 326, 332) from at least one edge device (e.g., 310A, 310B).

To receive the first response (e.g., 326, 332), prompt obtainment 312 may be performed. During prompt obtainment 312, (i) a first prompt may be submitted for processing by a first generative trained machine learning model, (ii) a determination may be made regarding whether there is access to information that may be relevant to the first prompt, or whether there is a lack of sufficient information regarding edge devices of the distributed system to service the first prompt (e.g., serviced by a management system (e.g., 300)).

Assume that (i) the first generative trained machine learning model is hosted by the management system (e.g., 300) and (ii) the first prompt may be obtained as an outcome of any number of processes/operations. For example, the first prompt may be (i) provided by a user based on the user's interaction with the distributed system via a user interface (UI), (ii) generated by software hosted by management system 300 as a result of an operation by the management system (e.g., 300), and/or (iii) any other type and/or quantity of processes/operations not to be limited by embodiments discussed herein.

For example, the first prompt may include (e.g., assuming that the first prompt is based on the previously mentioned user interaction via a UI) a string of text such as “perform an analysis of effects of heat dissipation on an operation of an edge device...” To perform the analysis requested by the first prompt, (i) temperature data, (ii) power consumption data, (iii) cooling system performance data, (iv) any other data, etc. may be needed to meet a request of the first prompt. As the third distributed system may include at least one subnet and/or at least one edge device of the at least one subnet, the management system (e.g., 300) may determine (i) to which of the at least one subnet to transmit the first prompt and/or (ii) what modification/s, addition/s, etc., if necessary, to perform on a content of the first prompt to generate at least one second prompt.

The management system (e.g., 300) may determine to which of the at least one subnet to transmit the first prompt and/or the second prompt by (i) ingesting, by the first generative trained machine learning model, (a) at least one location, (b) at least one power consumption metric, (c) at least one environmental condition, (d) any other second data, etc. of the at least one subnet and/or the at least one edge device of the at least one subnet and/or (ii) determining, for example, which of the at least one subnet and/or the at least one edge device may be affected by (a) the at least one location, (b) the at least one power consumption metric, (c) the at least one environmental condition, (d) the any other second data etc. Further, management system 300 may determine what modification/s, addition/s, etc., if necessary, to perform on the first prompt to generate the at least one second prompt by (i) ingesting, by the first generative trained machine learning model, at least the first prompt and/or, if necessary, first information of the at least one subnet and/or second information of the at least one edge device first that may be affected and/or (ii) generating the second prompt. The second prompt may include, for example, at least one detail of the analysis in the second prompt regarding (i) thermal throttling, (ii) hardware damage, (iii) energy efficiency, (iv) noise level, (v) any other behavior, performance, attribute, capability, etc. of the at least one subnet and/or the at least one edge device.

After prompt obtainment 312 has been performed, prompt logistical process 314 may be performed. During prompt logistical process 314, distribution of at least the first prompt and/or the second prompt to the at least one subnet may be performed. For example, the first prompt and/or the second prompt (e.g., 316, which may include the at least one modification, the at least one addition, etc. to the content of the first prompt) may be transmitted to the at least one subnet. The first prompt and/or the second prompt (e.g., 316) may be transmitted by sending the first prompt and/or the second prompt (e.g., 316) using a communication system (e.g., 308) of the third distributed system. The first prompt and/or the second prompt (e.g., 316) may be sent using, for example, (i) shared memory, (ii) a data stream, (iii) a message queue, etc.

After the first prompt and/or the second prompt (e.g., 316) has been transmitted, the at least one subnet (e.g., 304N) may receive the first prompt and/or the second prompt (e.g., 316). After the first prompt and/or the second prompt (e.g., 316) has been received, prompt obtainment process 318 may be performed. Prompt obtainment process 318 may be similar to prompt obtainment 312. However, prompt obtainment process 318 may be performed by the at least one subnet (e.g., 304N).

To perform prompt obtainment process 318, the at least one subnet (e.g., 304N) may perform (i) a second at least one modification, (ii) a second at least one addition, etc. to the first prompt and/or the second prompt (e.g., 316) to generate a third prompt. The third prompt may be transmitted to the at least one edge device of the at least one subnet. The third prompt may be generated by (i) ingesting, by a second generative trained machine learning model, the first prompt and/or the second prompt (e.g., 316) and (ii) performing the (a) the second at least one modification, (ii) the second at least one addition, etc. to the first prompt and/or the second prompt (e.g., 316) to generate the third prompt. The third prompt, for example, may include the string of a second text such as “diagnose at least one possible cause of frequent rebooting by the edge device...” The third prompt may be generated because, for example, the at least one edge device may be continuously rebooting due for an undetermined reason.

After prompt obtainment process 318 has been performed, context data collection process 320 may be performed by the at least one subnet (e.g., 304N). Context data collection process 320 may perform similarly to context data collection process 242 in FIG. 2D. During context data collection process 320, (i) the first prompt, (ii) the second prompt (e.g., 316), (iii) the third prompt, and/or (iv) any other prompt (e.g., 322, 328, etc.) obtained and/or generated during prompt obtainment process 318 and/or prompt obtainment process 312 may be assigned for transmission and/or transmitted to the at least one edge device and/or any other edge device (e.g., 310A, 310B, etc.) of the at least one subnet (e.g., 304N). Further, a first content of a first any other prompt (e.g., 322) and/or a second content of a second any other prompt (e.g., 328) (i) may be duplicative, (ii) may include small magnitude of differences, (iii) may include a large magnitude of differences, and/or (iv) may not include any matching content. The first prompt, the second prompt (e.g., 316), the third prompt, and/or the any other prompt (e.g., 322, 328, etc.) may be transmitted by sending (i) the first prompt, (ii) the second prompt (e.g., 316), (iii) the third prompt, and/or (iv) the any other prompt (e.g., 322, 328, etc.) using communication system 308 of the third distributed system. The first prompt, the second prompt (e.g., 316), the third prompt, and/or the any other prompt (e.g., 322, 328, etc.) may be sent using, for example, (i) the shared memory, (ii) the data stream, (iii) the message queue, etc.

An edge device (e.g., 310A, 310B, etc.) may receive (i) the first prompt, (ii) the second prompt (e.g., 316), (iii) the third prompt, and/or (iv) the any other prompt (e.g., 322, 328, etc.) from the at least one subnet (e.g., 304N). The edge device (e.g., 310A, 310B, etc.) may then perform a local response generation process (e.g., 324, 330). The local response generation process (e.g., 324, 330) may be similar to a second local response generation process (e.g., 251, 261, 271 from the description of FIG. 2D).

During the local response generation process (e.g., 324, 330), (i) (a) the first prompt, (b) the second prompt (e.g., 316), (c) the third prompt, and/or (d) the any other prompt (e.g., 322, 328, etc.) may be obtained by the at least one subnet (e.g., 304N), (ii) (a) the first prompt, (b) the second prompt (e.g., 316), (c) the third prompt, and/or (d) the any other prompt (e.g., 322, 328, etc.) may be used as input for a third generative trained machine learning model locally hosted by the at least one edge device (e.g., 310A, 310B) while local storage (e.g., a local database) of the at least one edge device (e.g., 310A, 310B) may be accessed to retrieve relevant information that may also be used as input for the third generative trained machine learning model along with (a) the first prompt, (b) the second prompt (e.g., 316), (c) the third prompt, and/or (d) the any other prompt (e.g., 322, 328, etc.), (iii) a first response may be obtained as output from the third generative trained machine learning model based on the input, and/or (iv) the first response may be transmitted (e.g., 326, 332) to the at least one subnet (e.g., 304N).

The first response from the at least one edge device (e.g., 310A, 310B) may include at least one data chunk concerning (a) the first prompt, (b) the second prompt (e.g., 316), (c) the third prompt, and/or (d) the any other prompt (e.g., 322, 328, etc.) that was transmitted to the at least one edge device (e.g., 310A, 310B). For example, as the third prompt includes the string of the second text (e.g., “diagnose at least one possible cause of frequent rebooting by the edge device...”), the first response may include (a) temperature data of the at least one edge device recorded for a number of days, (ii) at least one warning, alert, notification, etc. concerning an operation of at least one component of the at least one edge device, (iii) system health check data for the at least one component over the number of the days, etc. Further, a third content of the first response (e.g., 326, not 332, in this case) and/or a fourth content of a second first response (e.g., 332, not 326, in this case) (i) may be duplicative, (ii) may include the small magnitude of differences, (iii) may include the large magnitude of differences, and/or (iv) may not include any matching content. The first response (e.g., 326, 332) may be transmitted by sending the first response using the communication system (e.g., 308) of the third distributed system. The first response (e.g., 326, 332) may be sent using, for example, (i) the shared memory, (ii) the data stream, (iii) the message queue, etc.

The at least one subnet (e.g., 304N) may receive the first response (e.g., 326, 332) and/or performance of context data collection process 320 may be continued. During context data collection process 320, a plurality of first responses may be obtained by collecting each of first responses (e.g., 326, 332) from the transmission by the at least one edge device (e.g., 310A, 310B). The plurality of the first responses may include the at least one data chunk of each of the first response (e.g., 326, 332).

Thus, via the second interaction illustrated in FIG. 2G, a system in accordance with an embodiment may receive the first response (e.g., 326, 332) from the at least one edge device (e.g., 310A, 310B). Consequently, the third distributed system may be more likely to be able to provide desired computer implemented services by generating at least one response to at least one prompt that is used to extract specific, relevant, actionable, etc. information from local information of an edge device.

Turning to FIG. 2H, a third interaction diagram in accordance with an embodiment is shown. The second interaction diagram may illustrate data used in and data processing performed in generating a final response to the first prompt. Generally, the interactions shown in FIG. 2H may be performed after the interactions shown in FIG. 2G.

To generate the final response, subnet response generation process 334 may be performed. During subnet response generation process 334, the plurality of the first responses (from the description of FIG. 2G) may be ranked according to any magnitude of relevance to the first prompt. The plurality of the first responses may be ranked by (i) ingesting, by the second generative trained machine learning model, the plurality of the first responses, the first prompt, the second prompt (e.g., 316), the third prompt, the any other prompt (e.g., 322, 328, etc.), a first ranking criteria, etc., and/or (ii) generating a first ranking of the plurality of the first responses.

The first ranking criteria may include (i) a frequency of keywords found both in the plurality of the first responses and/or in the first prompt, the second prompt (e.g., 316), the third prompt, and/or the any other prompt (e.g., 322, 328, etc.), (ii) a measure of completeness, clarity, accuracy, contextual relevance, etc. of data in a response of the plurality of the first responses, (iii) any other criteria used to indicate a magnitude of relevance by the plurality of the first responses to the first prompt, the second prompt (e.g., 316), the third prompt, and/or the any other prompt (e.g., 322, 328, etc.).

At least one high-ranking first response (e.g., 336) of the plurality of the first responses may be transmitted to the management system (e.g., 300). The at least one high-ranking first response (e.g., 336) may be transmitted by sending the at least one first response (e.g., 336) using a communication system (e.g., 308) of the third distributed system. The at least one high-ranking first response (e.g., 336) may be sent using, for example, (i) shared memory, (ii) a data stream, (iii) a message queue, etc.

Prompt logistical process 314 (from the description of FIG. 2G) may continue to be performed. During prompt logistical process 314, the at least one high-ranking first response (e.g., 336) of at least one subnet (e.g., 304N) may be received by the management system (e.g., 300). The at least one high-ranking first response (e.g., 336) of at least one subnet (e.g., 304N) may be collected to obtain the plurality of high-ranking first responses.

After the plurality of the high-ranking first responses has been obtained, final response generation process 338 may be performed by the management system (e.g., 338). During final response generation process 338, a final response to the first prompt may be generated. To generate the final response, the first generative trained machine learning model (from the description of FIG. 2G) may be used. The final response may be generated by (i) ingesting, by the first generative trained machine learning model, the plurality of the high-ranking first responses, the first prompt, a second ranking criteria, etc., (ii) generating a second ranking of the plurality of the high-ranking first responses, (iii) using the second ranking to re-rank the plurality of the high-ranking first responses into the plurality of the final responses, and/or (iv) selecting, by the management system (e.g., 300) at least one high-ranking final response of the plurality of the final responses as the final response.

The second ranking criteria may include (i) a frequency of second keywords found both in the plurality of the final responses and/or in the first prompt, (ii) a measure of completeness, clarity, accuracy, contextual relevance, etc. of data in a response of the plurality of the final responses, (iii) any other criteria used to indicate a magnitude of relevance by the plurality of the final responses to the first prompt.

The final response may include a string of third text. The third text may provide a notification, a recommendation, an alert, etc. to serve as a respond to the first prompt. For example, the third text may, due to effects of heat dissipation (from the first prompt in the description of FIG. 2G), (i) recommend that at least one component of the at least one edge device be repaired and/or replaced, (ii) notify that a second at least one edge device has been shut down, and/or (iii) provide any information in the final response of the first prompt using local information from the at least one edge device.

Thus, via the third interaction illustrated in FIG. 2H, a system in accordance with an embodiment may generate the final response to the first prompt. Consequently, the third distributed system may be more likely to be able to provide desired computer implemented services by use high-ranking first responses of at least one subnet (e.g., 304N) to generate the final response to the first prompt.

Turning to FIG. 2I, a fourth interaction diagram in accordance with an embodiment is shown. The fourth interaction diagram may illustrate data used in and data processing performed in verifications of condition insights made by edge devices.

To verify the conditional insights, an edge device (e.g., 310A) may initially generate an insight during conditional insight generation process 350. During the process, edge device 310A may generate a response to a prompt as part of its operation using local data as a RAG data source. When generated, the response may indicate (i) a level of confidence in the response falling below a threshold, (ii) information that, if true, may change or confirm the response, and/or other information that may indicate that an insight may or may not be correct.

To verify the accuracy of the conditional insight, the edge devices may generate and distribute an insight package to management system 300 (e.g., via interactions 352, 354). The insight package may include a textual description regarding information necessary to verify the insight, a question regarding the information (e.g., and using which the information may be not be obtained to preserve privacy of the information itself), and/or other information to inform management system 300 of assistance necessary to verify the insight.

Once obtained, management system 300 may perform insight management process 355. During insight management process 355, management system 300 may perform a multi-stage RAG process, as discussed with respect to FIGS. 2F-2H.

For example, a set of prompts may be generated and distributed to edge subnet management systems (e.g., 306, via interaction 356). In turn, the subnet management system may generate derived prompts to other edge devices that are within corresponding subnets. In this example, at interaction 358 and 360, a derived prompt may be sent to edge device 310B. Edge device 310B may then generate and provide a response to edge subnet management system 306.

Edge subnet management system 306 may then generate and provide an aggregate response to management system 300 during interaction 362. The aggregate response, as discussed previously, may be based on the responses obtained from any number of edge devices. In this manner, both information from the edge devices may be collected and screened before being provided to management system 300.

Once the aggregate responses are obtained, management system 300 may generate a final response for the insight package using the aggregate responses as context and information (e.g., textual description of necessary information) from the insight package as a prompt for a local trained generative machine learning model to obtain a response.

The response may be provided back to the edge devices as an insight verification at interaction 364. Once obtained, the receiving edge device may perform an insight driven management process 366. The insight driven management process 366 may use the insight verification (e.g., data usable to verify or dismiss the conditional insight as being accurate/inaccurate) to select one or more actions to perform to manage operation of the edge device.

The actions may be any type and quantity of management actions. The actions may update operation of the edge device to address the conditional insight (e.g., may indicate that one or more actions should be taken to manage the operation of the edge device, may indicate likely occurrences of events in the future, etc.).

Thus, using the flow shown in FIG. 2I, embodiments disclosed herein may facilitate verification of conditional insights in distributed system to facilitate management of various components of the distributed system.

Any of the processes illustrated using the second set of shapes and interactions illustrated using the third set of shapes may be performed, in part or whole, by digital processors (e.g., central processors, processor cores, etc.) that execute corresponding instructions (e.g., computer code/software). Execution of the instructions may cause the digital processors to initiate performance of the processes. Any portions of the processes may be performed by the digital processors and/or other devices. For example, executing the instructions may cause the digital processors to perform actions that directly contribute to performance of the processes, and/or indirectly contribute to performance of the processes by causing (e.g., initiating) other hardware components to perform actions that directly contribute to the performance of the processes.

Any of the processes illustrated using the second set of shapes and interactions illustrated using the third set of shapes may be performed, in part or whole, by special purpose hardware components such as digital signal processors, application specific integrated circuits, programmable gate arrays, graphics processing units, data processing units, and/or other types of hardware components. These special purpose hardware components may include circuitry and/or semiconductor devices adapted to perform the processes. For example, any of the special purpose hardware components may be implemented using complementary metal-oxide semiconductor based devices (e.g., computer chips).

Any of the processes and interactions may be implemented using any type and number of data structures. The data structures may be implemented using, for example, tables, lists, linked lists, unstructured data, data bases, and/or other types of data structures. Additionally, while described as including particular information, it will be appreciated that any of the data structures may include additional, less, and/or different information from that described above. The informational content of any of the data structures may be divided across any number of data structures, may be integrated with other types of information, and/or may be stored in any location.

As discussed above, the components of FIGS. 2E-2F may perform various methods to manage operation of a distributed system. FIGS. 3A-3B illustrate methods that may be performed by the components of the system of FIGS. 2E-2F. In the diagrams discussed below and shown in FIGS. 3A-3B, any of the operations may be repeated, performed in different orders, and/or performed in parallel with or in a partially overlapping in time manner with other operations.

Turning to FIG. 3A, a first flow diagram illustrating a method of managing the operation of the distributed system in accordance with an embodiment is shown. The method may be performed, for example, by any of the components of the system of FIGS. 2E-2F, and/or other components not shown therein.

At operation 400, a plurality of second prompts for subnets of the distributed system, each of the subnets comprising a subnet manager and at least one of the edge devices, may be obtained by the management system and using the prompt. The plurality of the second prompts may be derived by (i) performing at least one modification, based on at least one attribute and/or at least one capability of at least one edge device of the at least one subnet, to information of the prompt and/or (ii) generating, using the at least one modification of the information, the second prompts.

At operation 402, first retrieval augmented generation (RAG) processing may be initiated by the management system of the plurality of the second prompts by the subnets using locally available data hosted by portions of the edge devices that are members of each of the subnets, the locally available data being used as knowledge sources for the first RAG processing to obtain a plurality of first responses from the subnets. The first RAG processing may be initiated by providing, by the management system, the plurality of the second prompts to respective subnet managers of the subnets to initiate generation and/or distribution of derived prompts to portions of the edge devices that are members of the respective subnets. The plurality of the second prompts may be provided by transmitting, by the management system and to each subnet manager of the subnet managers, a second prompt of the second prompts.

At operation 404, second RAG processing of the prompt may be performed by the management system using the plurality of the first responses as a knowledge source for the second RAG processing to obtain a final response. The second RAG processing may be performed by (i) rank ordering the plurality of first responses based on relevancy to the prompt and/or (ii) using a portion of the plurality of the first responses as indicated by the rank ordering as context data for the prompt. The second RAG processing may be further performed by ingesting, by a generative trained machine learning model, at least the plurality of the first responses, to generate the final response.

At operation 406, computer implemented services may be provided by the management system using the final response. The computer implemented services may be provided by providing information from (i) the notification, (ii) the recommendation, (iii) the result, etc. of the final response in a plan to (i) maintain, (ii) optimize, (iii) remediate, etc. at least one data processing system that is used to provide computer implemented services.

The method may end following operation 406.

Thus, via the method shown in FIG. 3A, embodiments herein may improve a likelihood of managing operation of a distributed system in a manner that is better able to, for example, proactively identify and remediate conditions that may otherwise impair operation of the distributed system. By improving the likelihood of managing the operation of the distributed system, the distributed system may be more likely to provide desirable computer implemented services.

Turning to FIG. 3B, a second flow diagram illustrating a method of managing the operation of edge devices of a distributed system in accordance with an embodiment is shown. The method may be performed, for example, by any of the components of the system of FIGS. 2E-2F, and/or other components not shown therein.

As discussed with respect to FIG. 3A, management systems may retrieve and use information from edge devices to satisfy inquiries regarding, for example, condition of the distributed system. However, as part of their operation, edge devices may, using local data, generate insights (e.g., by prompting local inference models) that may be treated as conditional. A conditional insight may be an insight that is of insufficient confidence (e.g., when compared to criteria, which may indicate a minimum threshold). When such conditional insights are generated, the edge devices may communicate with the management system to initiate verification of the accuracy of the conditional insights.

At operation 410, an insight package requesting information for verification of an insight for management of operation of an edge device is obtained by a management system. The edge device may be part of a subnet managed by the management system. The insight package may be obtained by, for example, reading it from storage, receiving it from another device, generating it, and/or via other methods.

The insight package may include a textual description of the information (e.g., ask directly for it), or one or more questions regarding the information. The questions may be selected so that the information on which answers are based cannot be recovered from the answers. Consequently, the information itself may, in an embodiment, remain siloed without being provided to the edge device (or otherwise distributed), while still enabling for the condition insight accuracy to be verified.

At operation 412, a plurality of second prompts for subsets of the distributed system may be obtained by the management system using the information as a prompt. The second prompts may facilitate retrieval of context information from edge devices to generate a response to the prompt (e.g., that is likely to be accurate). The second prompts may be generated via any method (e.g., may be rule based, may use a large language model and a prompt to derive the second prompts, may use templates for the second prompts that are populated based on the textual description, etc.).

At operation 414, first retrieval augmented generation (RAG) processing of the plurality of the second prompts by the subnets using locally available data hosted by portions of the edge devices that are members of each of the subnets may be initiated by the management system. The locally available data may be used as knowledge sources for the first RAG processing to obtain a plurality of first responses from the subnets.

To initiate the first RAG processing, the management system may distribute the plurality of second prompts to corresponding subnet managers of the subnets. The subnets managers may, in turn, generate derived prompts which may be selectively distributed to the edge devices so that only edge devices likely to provide desired responses may receive the derived prompts.

The prompts generated by the edge devices may then be aggregated by respective subnet managers. The subnet managers may in turn use the respective groups of responses to generate an aggregated response, as discussed with respect to FIGS. 2E-2I. Any ranking and selection process may be used in generation of the aggregate response.

The resulting aggregate responses from the respective subnet managers may be provided back to the management system as the plurality of the first responses.

At operation 416, second RAG processing of the prompt using the plurality of the first responses as a knowledge data source for the second RAG processing may be performed by the management system to obtain a final response. The second RAG processing may be performed by ingesting the prompt and using the first plurality of response as a RAG data source and through which context information for the prompt may be obtained. The prompt and context may then be ingested by a local trained generative machine learning model hosted by the management system to obtain the final response.

At operation 418, the final response may be provided to the edge device by the management system to facilitate continued provisioning of computer implemented services.

Once provided, the edge device may, for example, (i) use the final response to confirm accuracy of an insight indicated by the insight package (e.g., the insight package may be generated for the insight), (ii) select, by the edge device, a management action based on the confirmed accuracy, (iii) perform the management action to update operation of the edge device to obtain an updated edge device, and/or (iv) provide, by the updated edge device, computer implemented services. The edge device may be adapted to use the insight to manage its operation. For example, the edge device may include an automation framework that may, based on the insight, modify a configuration of the edge device; change a security posture of the edge device; disable a software component hosted by the edge device; and/or change workload acceptability criteria for the edge device (e.g., may reduce workloads that are accepted, be more/less picky in agreeing to workloads when the edge device is likely/unlikely to become impaired).

Thus, via the method shown in FIG. 3B, embodiments herein may improve a likelihood of managing operation of a distributed system in a manner that is better able to, for example, proactively identify and remediate conditions that may otherwise impair operation of the distributed system. By improving the likelihood of managing the operation of the distributed system, the distributed system may be more likely to provide desirable computer implemented services. The disclosed method may do so by enabling edge devices to analyze condition insights before taking action on the conditional insights.

Any of the components illustrated in FIGS. 1-2I may be implemented with one or more computing devices. Turning to FIG. 4, a block diagram illustrating an example of a data processing system (e.g., a computing device) in accordance with an embodiment is shown. For example, system 600 may represent any of data processing systems described above performing any of the processes or methods described above. System 600 can include many different components. These components can be implemented as integrated circuits (ICs), portions thereof, discrete electronic devices, or other modules adapted to a circuit board such as a motherboard or add-in card of the computer system, or as components otherwise incorporated within a chassis of the computer system. Note also that system 600 is intended to show a high level view of many components of the computer system. However, it is to be understood that additional components may be present in certain implementations and furthermore, different arrangement of the components shown may occur in other implementations. System 600 may represent a desktop, a laptop, a tablet, a server, a mobile phone, a media player, a personal digital assistant (PDA), a personal communicator, a gaming device, a network router or hub, a wireless access point (AP) or repeater, a set-top box, or a combination thereof. Further, while only a single machine or system is illustrated, the term “machine” or “system” shall also be taken to include any collection of machines or systems that individually or jointly execute a set (or multiple sets) of instructions to perform any one or more of the methodologies discussed herein.

In one embodiment, system 600 includes processor 601, memory 603, and devices 605-607 via a bus or an interconnect 610. Processor 601 may represent a single processor or multiple processors with a single processor core or multiple processor cores included therein. Processor 601 may represent one or more general-purpose processors such as a microprocessor, a central processing unit (CPU), or the like. More particularly, processor 601 may be a complex instruction set computing (CISC) microprocessor, reduced instruction set computing (RISC) microprocessor, very long instruction word (VLIW) microprocessor, or processor implementing other instruction sets, or processors implementing a combination of instruction sets. Processor 601 may also be one or more special-purpose processors such as an application specific integrated circuit (ASIC), a cellular or baseband processor, a field programmable gate array (FPGA), a digital signal processor (DSP), a network processor, a graphics processor, a network processor, a communications processor, a cryptographic processor, a co-processor, an embedded processor, or any other type of logic capable of processing instructions.

Processor 601, which may be a low power multi-core processor socket such as an ultra-low voltage processor, may act as a main processing unit and central hub for communication with the various components of the system. Such processor can be implemented as a system on chip (SoC). Processor 601 is configured to execute instructions for performing the operations discussed herein. System 600 may further include a graphics interface that communicates with optional graphics subsystem 604, which may include a display controller, a graphics processor, and/or a display device.

Processor 601 may communicate with memory 403, which in one embodiment can be implemented via multiple memory devices to provide for a given amount of system memory. Memory 403 may include one or more volatile storage (or memory) devices such as random access memory (RAM), dynamic RAM (DRAM), synchronous DRAM (SDRAM), static RAM (SRAM), or other types of storage devices. Memory 403 may store information including sequences of instructions that are executed by processor 601, or any other device. For example, executable code and/or data of a variety of operating systems, device drivers, firmware (e.g., input output basic system or BIOS), and/or applications can be loaded in memory 403 and executed by processor 601. An operating system can be any kind of operating systems, such as, for example, Windows® operating system from Microsoft®, Mac OS®/iOS® from Apple, Android® from Google®, Linux®, Unix®, or other real-time or embedded operating systems such as VxWorks.

System 600 may further include IO devices such as devices (e.g., 605, 606, 607, 608) including network interface device(s) 605, optional input device(s) 606, and other optional IO device(s) 607. Network interface device(s) 605 may include a wireless transceiver and/or a network interface card (NIC). The wireless transceiver may be a WiFi transceiver, an infrared transceiver, a Bluetooth transceiver, a WiMax transceiver, a wireless cellular telephony transceiver, a satellite transceiver (e.g., a global positioning system (GPS) transceiver), or other radio frequency (RF) transceivers, or a combination thereof. The NIC may be an Ethernet card.

Input device(s) 606 may include a mouse, a touch pad, a touch sensitive screen (which may be integrated with a display device of optional graphics subsystem 604), a pointer device such as a stylus, and/or a keyboard (e.g., physical keyboard or a virtual keyboard displayed as part of a touch sensitive screen). For example, input device(s) 606 may include a touch screen controller coupled to a touch screen. The touch screen and touch screen controller can, for example, detect contact and movement or break thereof using any of a plurality of touch sensitivity technologies, including but not limited to capacitive, resistive, infrared, and surface acoustic wave technologies, as well as other proximity sensor arrays or other elements for determining one or more points of contact with the touch screen.

IO devices 607 may include an audio device. An audio device may include a speaker and/or a microphone to facilitate voice-enabled functions, such as voice recognition, voice replication, digital recording, and/or telephony functions. Other IO devices 607 may further include universal serial bus (USB) port(s), parallel port(s), serial port(s), a printer, a network interface, a bus bridge (e.g., a PCI-PCI bridge), sensor(s) (e.g., a motion sensor such as an accelerometer, gyroscope, a magnetometer, a light sensor, compass, a proximity sensor, etc.), or a combination thereof. IO device(s) 607 may further include an imaging processing subsystem (e.g., a camera), which may include an optical sensor, such as a charged coupled device (CCD) or a complementary metal-oxide semiconductor (CMOS) optical sensor, utilized to facilitate camera functions, such as recording photographs and video clips. Certain sensors may be coupled to interconnect via a sensor hub (not shown), while other devices such as a keyboard or thermal sensor may be controlled by an embedded controller (not shown), dependent upon the specific configuration or design of system 600.

To provide for persistent storage of information such as data, applications, one or more operating systems and so forth, a mass storage (not shown) may also couple to processor 601. In various embodiments, to enable a thinner and lighter system design as well as to improve system responsiveness, this mass storage may be implemented via a solid state device (SSD). However, in other embodiments, the mass storage may primarily be implemented using a hard disk drive (HDD) with a smaller amount of SSD storage to act as an SSD cache to enable non-volatile storage of context state and other such information during power down events so that a fast power up can occur on re-initiation of system activities. Also a flash device may be coupled to processor 601, e.g., via a serial peripheral interface (SPI). This flash device may provide for non-volatile storage of system software, including a basic input/output software (BIOS) as well as other firmware of the system.

Storage device 608 may include computer-readable storage medium 609 (also known as a machine-readable storage medium or a computer-readable medium) on which is stored one or more sets of instructions or software (e.g., processing module, unit, and/or processing module/unit/logic 628) embodying any one or more of the methodologies or functions described herein. Processing module/unit/logic 628 may represent any of the components described above. Processing module/unit/logic 628 may also reside, completely or at least partially, within memory 603 and/or within processor 601 during execution thereof by system 600, memory 603 and processor 601 also constituting machine-accessible storage media. Processing module/unit/logic 628 may further be transmitted or received over a network via network interface device(s) 605.

Computer-readable storage medium 609 may also be used to store some software functionalities described above persistently. While computer-readable storage medium 609 is shown in an exemplary embodiment to be a single medium, the term “computer-readable storage medium” should be taken to include a single medium or multiple media (e.g., a centralized or distributed database, and/or associated caches and servers) that store the one or more sets of instructions. The terms “computer-readable storage medium” shall also be taken to include any medium that is capable of storing or encoding a set of instructions for execution by the machine and that cause the machine to perform any one or more of the methodologies of embodiments disclosed herein. The term “computer-readable storage medium” shall accordingly be taken to include, but not be limited to, solid-state memories, and optical and magnetic media, or any other non-transitory machine-readable medium.

Processing module/unit/logic 628, components and other features described herein can be implemented as discrete hardware components or integrated in the functionality of hardware components such as ASICS, FPGAs, DSPs or similar devices. In addition, processing module/unit/logic 628 can be implemented as firmware or functional circuitry within hardware devices. Further, processing module/unit/logic can be implemented in any combination hardware devices and software components.

Note that while system 600 is illustrated with various components of a data processing system, it is not intended to represent any particular architecture or manner of interconnecting the components; as such details are not germane to embodiments disclosed herein. It will also be appreciated that network computers, handheld computers, mobile phones, servers, and/or other data processing systems which have fewer components or perhaps more components may also be used with embodiments disclosed herein.

Some portions of the preceding detailed descriptions have been presented in terms of algorithms and symbolic representations of operations on data bits within a computer memory. These algorithmic descriptions and representations are the ways used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities.

It should be borne in mind, however, that all of these and similar terms are to be associated with the appropriate physical quantities and are merely convenient labels applied to these quantities. Unless specifically stated otherwise as apparent from the above discussion, it is appreciated that throughout the description, discussions utilizing terms such as those set forth in the claims below, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

Embodiments disclosed herein also relate to an apparatus for performing the operations herein. Such a computer program is stored in a non-transitory computer readable medium. A non-transitory machine-readable medium includes any mechanism for storing information in a form readable by a machine (e.g., a computer). For example, a machine-readable (e.g., computer-readable) medium includes a machine (e.g., a computer) readable storage medium (e.g., read only memory (“ROM”), random access memory (“RAM”), magnetic disk storage media, optical storage media, flash memory devices).

The processes or methods depicted in the preceding figures may be performed by processing logic that comprises hardware (e.g. circuitry, dedicated logic, etc.), software (e.g., embodied on a non-transitory computer readable medium), or a combination of both. Although the processes or methods are described above in terms of some sequential operations, it should be appreciated that some of the operations described may be performed in a different order. Moreover, some operations may be performed in parallel rather than sequentially.

Embodiments disclosed herein are not described with reference to any particular programming language. It will be appreciated that a variety of programming languages may be used to implement the teachings of embodiments disclosed herein.

In the foregoing specification, embodiments have been described with reference to specific exemplary embodiments thereof. It will be evident that various modifications may be made thereto without departing from the broader spirit and scope of the embodiments disclosed herein as set forth in the following claims. The specification and drawings are, accordingly, to be regarded in an illustrative sense rather than a restrictive sense.

What is claimed is:

1. A method for managing operation of a distributed system, the method comprising:
obtaining, by a management system and from an edge device of a subnet of the subnets, an insight package requesting information for verification of an insight for management of operation of the edge device;
obtaining, by the management system and using the information as a prompt, a plurality of second prompts for subnets of the distributed system;
initiating, by the management system, first retrieval augmented generation (RAG) processing of the plurality of the second prompts by the subnets using locally available data hosted by portions of the edge devices that are members of each of the subnets, the locally available data being used as knowledge sources for the first RAG processing to obtain a plurality of first responses from the subnets;
performing, by the management system, second RAG processing of the prompt using the plurality of the first responses as a knowledge source for the second RAG processing to obtain a final response; and
providing, by the management system, the final response to the edge device to facilitate continued provisioning of computer implemented services.

2. The method of claim 1, further comprising:
using, by the edge device, the final response to confirm accuracy of an insight indicated by the insight package;
selecting, by the edge device, a management action based on the confirmed accuracy;
performing, by the edge device, the management action to update operation of the edge device to obtain an updated edge device; and
providing, by the updated edge device, computer implemented services.

3. The method of claim 2, wherein the management action is one selected from a group of management actions consisting of:
modifying a configuration of the edge device;
changing a security posture of the edge device;
disabling a software component hosted by the edge device; and
changing workload acceptability criteria for the edge device.

4. The method of claim 1, wherein the insight package comprises a textual description of the information.

5. The method of claim 1, wherein the insight package comprises a textual description of a question regarding the information, and the information cannot be recovered using an answer to the question.

6. The method of claim 1, wherein a first response of the plurality of the first responses comprises:
a statement that is based on a plurality of data chunks from a portion of the edge devices that are members of a first subnet of the subnets.

7. The method of claim 6, wherein the first response is a portion of responses obtained from the portion of the edge devices during individual RAG processes performed during the first RAG processing.

8. The method of claim 7, wherein the plurality of the first responses is discriminated from the responses using ranking criteria.

9. The method of claim 8, wherein the ranking criteria takes into account, at least, consistency between the plurality of the data chunks as a ranking basis.

10. The method of claim 1, wherein initiating the first RAG processing comprises:
providing, by the management system, the plurality of the second prompts to respective subnet managers of the subnets to initiate generation and distribution of derived prompts to portions of the edge devices that are members of the respective subnets.

11. A non-transitory machine-readable medium having instructions stored therein, which when executed by a processor, cause the processor to perform operations for managing operation of a distributed system, the operations comprising:
obtaining, by a management system and from an edge device of a subnet of the subnets, an insight package requesting information for verification of an insight for management of operation of the edge device;
obtaining, by the management system and using the information as a prompt, a plurality of second prompts for subnets of the distributed system;
initiating, by the management system, first retrieval augmented generation (RAG) processing of the plurality of the second prompts by the subnets using locally available data hosted by portions of the edge devices that are members of each of the subnets, the locally available data being used as knowledge sources for the first RAG processing to obtain a plurality of first responses from the subnets;
performing, by the management system, second RAG processing of the prompt using the plurality of the first responses as a knowledge source for the second RAG processing to obtain a final response; and
providing, by the management system, the final response to the edge device to facilitate continued provisioning of computer implemented services.

12. The non-transitory machine-readable medium of claim 11, wherein the operations further comprise:
using, by the edge device, the final response to confirm accuracy of an insight indicated
by the insight package;
selecting, by the edge device, a management action based on the confirmed accuracy;
performing, by the edge device, the management action to update operation of the edge device to obtain an updated edge device; and
providing, by the updated edge device, computer implemented services.

13. The non-transitory machine-readable medium of claim 12, wherein the management action is one selected from a group of management actions consisting of:
modifying a configuration of the edge device;
changing a security posture of the edge device;
disabling a software component hosted by the edge device; and
changing workload acceptability criteria for the edge device.

14. The non-transitory machine-readable medium of claim 11, wherein the insight package comprises a textual description of the information.

15. The non-transitory machine-readable medium of claim 11, wherein the insight package comprises a textual description of a question regarding the information, and the information cannot be recovered using an answer to the question.

16. A system, comprising:
a processor; and
a memory coupled to the processor to store instructions, which when executed by the processor, cause the processor to perform operations managing operation of a distributed system, the operations comprising:
obtaining, by a management system and from an edge device of a subnet of the subnets, an insight package requesting information for verification of an insight for management of operation of the edge device;
obtaining, by the management system and using the information as a prompt, a plurality of second prompts for subnets of the distributed system;
initiating, by the management system, first retrieval augmented generation (RAG) processing of the plurality of the second prompts by the subnets using locally available data hosted by portions of the edge devices that are members of each of the subnets, the locally available data being used as knowledge sources for the first RAG processing to obtain a plurality of first responses from the subnets;
performing, by the management system, second RAG processing of the prompt using the plurality of the first responses as a knowledge source for the second RAG processing to obtain a final response; and
providing, by the management system, the final response to the edge device to facilitate continued provisioning of computer implemented services.

17. The system of claim 16, wherein the operations further comprise:
using, by the edge device, the final response to confirm accuracy of an insight indicated by the insight package;
selecting, by the edge device, a management action based on the confirmed accuracy;
performing, by the edge device, the management action to update operation of the edge device to obtain an updated edge device; and
providing, by the updated edge device, computer implemented services.

18. The system of claim 17, wherein the management action is one selected from a group of management actions consisting of:
modifying a configuration of the edge device;
changing a security posture of the edge device;
disabling a software component hosted by the edge device; and
changing workload acceptability criteria for the edge device.

19. The system of claim 16, wherein the insight package comprises a textual description of the information.

20. The system of claim 16, wherein the insight package comprises a textual description of a question regarding the information, and the information cannot be recovered using an answer to the question.
